(19) United States
(12) Patent Application Publication
(10) Pub. No.: US 2012/0238384 A1
(43) Pub. Date: Sep. 20, 2012

(54) LOCKING CONTINUOUSLY VARIABLE TRANSMISSION (CVT)

(75) Inventors: Gary D. Lee, Orem, UT (US); William M. Decker, Salt Lake City, UT (US); Eric E. Aston, Salt Lake City, UT (US)

(73) Assignee: VMT Technologies, LLC., Provo, UT (US)

(21) Appl. No.: 13/427,354

(22) Filed: Mar. 22, 2012

Related U.S. Application Data
(63) Continuation-in-part of application No. 12/876,862, filed on Sep. 7, 2010.
(60) Provisional application No. 61/276,121, filed on Sep. 8, 2009.
(60) Provisional application No. 61/240,646, filed on Sep. 8, 2009.
(60) Provisional application No. 61/281,460, filed on Nov. 18, 2009.
(60) Provisional application No. 61/294,388, filed on Jan. 12, 2010.
(60) Provisional application No. 61/307,380, filed on Feb. 23, 2010.
(60) Provisional application No. 61/323,795, filed on Apr. 13, 2010.
(60) Provisional application No. 61/378,875, filed on Aug. 31, 2010.
(60) Provisional application No. 61/466,167, filed on Mar. 22, 2011.
(60) Provisional application No. 61/471,009, filed on Apr. 1, 2011.
(60) Provisional application No. 61/480,200, filed on Apr. 28, 2011.
(60) Provisional application No. 61/568,364, filed on Dec. 8, 2011.

(51) Int. Cl. F16H 9/14

(52) U.S. Cl. 474/25

(57) ABSTRACT

In one example, a transmission is provided that includes a sheave of selectively variable configuration, a driven member configured to engage the sheave, and a plurality of drive members configured for radial movement to selectively engage the driven member. The transmission may be operable in one or more of the following modes: traction mode, integer mode, I_{N} mode, and infinite mode.

### RELATED APPLICATIONS

The present application is a continuation-in-part (CIP) of, and claims priority to, U.S. patent application Ser. No. 12/876,862, entitled INFINITELY VARIABLE TRANSMISSION WITH SPROCKET CORRECTION MECHANISM, filed Sep. 7, 2010, which claims priority to: U.S. Provisional Patent Application Ser. 61/276,121, entitled INFINITELY VARIABLE TRANSMISSION, filed Sep. 8, 2009; U.S. Provisional Patent Application Ser. 61/240,646, entitled REVERSE DIFFERENTIAL WITH ENGAGED NEUTRAL, filed Sep. 8, 2009; U.S. Provisional Patent Application Ser. 61/281,460, entitled INFINITELY VARIABLE TRANSMISSION, filed Nov. 18, 2009; U.S. Provisional Patent Application Ser. 61/294,388, entitled INFINITELY VARIABLE TRANSMISSION, filed Jan. 12, 2010; U.S. Provisional Patent Application Ser. 61/307,380, entitled INFINITELY VARIABLE TRANSMISSION, filed Feb. 23, 2010; U.S. Provisional Patent Application Ser. 61/323,795, entitled INFINITELY VARIABLE TRANSMISSION, filed Apr. 13, 2010; and, U.S. Provisional Patent Application Ser. 61/378,875, entitled INFINITELY VARIABLE TRANSMISSION, filed Aug. 31, 2010. The present application also claims priority to: U.S. Provisional Patent Application Ser. 61/466,167, entitled LOCKING CONTINUOUSLY VARIABLE TRANSMISSION (CVT), filed Mar. 22, 2011; U.S. Provisional Patent Application Ser. 61/471,009, entitled SECTOR GEAR ENGAGEMENT DRIVE, filed Apr. 1, 2011; U.S. Provisional Patent Application Ser. 61/480,200, entitled SECTOR GEAR ENGAGEMENT DRIVE, filed Apr. 28, 2011; and, U.S. Provisional Patent Application Ser. 61/568,364, entitled SECTOR GEAR ENGAGEMENT DRIVE AND ADJUSTABLE IDLER/TENSIONER, filed Dec. 8, 2011. All of the aforementioned applications are incorporated herein by this reference in their respective entireties.

### BACKGROUND

1. The Field of the Invention

The present application relates to the field of transmission systems and related processes and components. More particularly, the present invention relates to methods, systems, sub-systems, assemblies, and components for providing substantially constant engagement during power transmission, and during changes of a relatively large number of gear ratios in relatively small increments.

2. Related Technology

Conventional transmissions may be problematic insofar as they are operable at only a small number of discrete drive ratios, and/or insofar as they may require temporary uncoupling of the engine from the transmission to effect a gear ratio change.

### BRIEF SUMMARY OF SOME ASPECTS OF THE DISCLOSURE

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

Disclosed embodiments are generally concerned with transmission systems and associated components and systems. Embodiments within the scope of this disclosure may include aspects of the present disclosure together with any one or more of the following elements, and features of elements, in any combination: a group of one or more drive members, each of which is configured to selectively engage a driven member; a group of one or more drive members which are configured to successively engage, a driven member; a group of one or more drive members which are rotatable about a common axis; a group of one or more drive members, each of which is configured to rotate about its own axis; a group of one or more drive members, each of which is configured to rotate about its own axis, and the drive members are further configured to rotate about a common axis; a group of one or more drive members, each of which is configured to move radially relative to a common axis; a group of one or more drive members, each of which is configured to move radially relative to a common axis, and each of the drive members is further configured to rotate about its own respective axis; a group of one or more drive members, each of which is configured to move radially relative to a common axis, and each of the drive members is further configured to rotate about its own respective axis, and the drive members are further configured to rotate about the common axis; a drive member configured to be rotated about its own axis when the drive member is out of engagement with a driven member; a drive member that comprises a gear or a portion of a gear; a drive member that comprises a moon gear; a drive member that comprises a sector gear; a sector gear configured to move radially relative to a first axis, further configured to rotate about the first axis, and further configured to rotate about a second axis; a drive member that can be indexed to virtually any desired angle necessary to engage an associated driven member; a driven member in the form of a chain or belt; a driven member in the form of a gear; a group of one or more drive members and an associated driven member, where the drive members and the driven member are configured to be operated together at a relatively large number of drive ratios, where the drive ratios may include both integer and non-integer drive ratios; a group of driven members and an associated drive member, where the drive member may be implemented as a belt or chain, for example, and the driven members may comprise moon gears which may or may not be in the form of sector gears; a correction mechanism configured to selectively adjust the radial and/or rotational position of one or more drive members relative to a driven member; a group of one or more drive members and an associated driven member, where the drive members and the driven member are configured to be operated together in an integer and/or I_{N} mode; a group of drive members configured to be maintained at respective index positions that correspond with the drive ratio desired to be employed; one or more drive members configured to be maintained at respective index positions that correspond with the drive ratio desired to be employed, where the drive members are fixed at their respective index positions until a change is made to an associated drive ratio; a transmission that includes one or more drive members and a driven member configured to engage the one or more drive members; a transmission in the form of a locking CVT; a vehicle that includes a transmission; and, a vehicle that includes a prime mover such as an engine for example, a transmission, and a drive train connected to the prime mover and the transmission.

Following is a brief list of some example embodiments. It should be noted that these, and other embodiments disclosed herein, are not necessarily mutually exclusive of each other and may share one or more common aspects.

In a first example embodiment, a transmission is provided that includes a sheave of selectively variable configuration, a driven member configured to engage the sheave, and a plurality of drive members configured for radial movement to selectively engage the driven member. The transmission may be operable in one or more of the following modes: traction mode, integer mode, I_{N} mode, and infinite mode.

In a second example embodiment, the transmission of the first example embodiment may further include an indexing mechanism configured to adjust a position of a drive member relative to the driven member when the drive member is not engaged with the driven member.

In a third example embodiment, a method for operating the transmission of either of the first and second embodiments includes initiating a shift cycle, adjusting sheave spacing to correspond to a desired drive ratio, and adjusting driven member tension during sheave spacing adjustments so as to maintain a desired driven member slip rate.

In a fourth example embodiment, a method for operating the transmission of either of the first and second embodiments includes initiating a shift cycle, disengaging the drive members from the driven member, adjusting sheave spacing to correspond to a desired drive ratio, adjusting an index position of the drive members such that the drive members engage the driven member in a predetermined fashion, engaging the drive members with the driven member, and maintaining a desired slack side driven member tension.

In a fifth example embodiment, a method for operating the transmission of either of the first and second embodiments includes initiating a shift cycle, disengaging the drive members from the driven member, adjusting sheave spacing to correspond to a desired drive ratio, controlling a relative position of the driven member with respect to an index line of the drive members by adjusting power of an engine operably coupled to the transmission of either the first or second embodiments and the driven member tension, engaging the drive members with the driven member, and maintaining a desired slack side driven member tension.

In a sixth example embodiment, the method of the fourth or fifth example embodiments further includes maintaining an index position of each drive member until another shift cycle is initiated.

In a seventh example embodiment, a vehicle includes the transmission of either the first or second embodiments, as well as an engine configured to be coupled directly or indirectly to the transmission, and a control system configured to control one or more aspects of the operation of the transmission.

In any of the aforementioned embodiments, the drive member may comprise a gear, such as a moon gear, or a sector gear, and the driven member may comprise a chain or belt.

### BRIEF DESCRIPTION OF THE DRAWINGS

To further clarify the aspects of embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1G illustrate various views of one example embodiment of an infinitely variable transmission;

FIGS. 2A and 2B illustrate alternative views of the infinitely variable transmission of FIGS. 1A-1G, in which various components have been removed so as to illustrate interior components of the transmission;

FIGS. 3A and 3B also illustrate alternative views of the infinitely variable transmission of FIGS. 1A-1G, with various other components having been removed to illustrate still other interior components of the transmission;

FIGS. 4A-4C illustrate a transmission with a reverse differential that may provide an engaged neutral and is usable with the transmission of FIGS. 1A-1G;

FIGS. 5A-5C illustrate an alternative embodiment of a transmission according to some aspects of the present invention;

FIG. 6 illustrates an example transmission according to embodiments of the present invention, and includes a chain tensioner for adjusting the slack in a chain mounted to a sheave;

FIG. 7A illustrates an isometric view of a sheave assembly usable with embodiments of a transmission as described herein;

FIG. 7B illustrates a side view of the sheave assembly of FIG. 7A;

FIG. 7C illustrates a cut-away view of the sheave assembly of FIG. 7B;

FIG. 7D illustrates further aspects of an example sheave assembly;

FIGS. 8A and 8B illustrate additional views of a transmission having a sheave assembly similar to that in FIGS. 7A-7D;

FIG. 9 schematically illustrates one example embodiment of a transmission having a gear position correction mechanism;

FIGS. 10A-10F illustrate various views of a transmission having a gear position correction mechanism and a gear locking mechanism;

FIGS. 11A-11E illustrate another example embodiment of a transmission having a gear position correction mechanism, gear locking mechanism, and gear ratio change mechanism;

FIG. 12 is a schematic illustration of various aspects of moon gears engaged with a chain that is engaged with a variator;

FIG. 13 is a schematic illustration of various aspects of moon gears disengage from a chain that is engaged with a variator;

FIG. 14 is a schematic illustration demonstrating the relation between variator width and operating diameter; and

FIG. 15 is a schematic illustration indicating the role of a chain tensioner.

### DETAILED DESCRIPTION OF SOME EXAMPLE EMBODIMENTS

This description relates to transmission systems and associated components and systems. More particularly, the description herein relates to transmission systems that can convey power from a source to a load using gear ratios that are changeable in very small, perhaps infinitely small, increments. More particularly still, the description relates to transmission systems usable with any of a variety of technologies, and which can operate with an engaged neutral and move in very small, perhaps infinitely small, increments either forward or reverse out of the engaged neutral.

Reference will now be made to the drawings to describe various aspects of example embodiments of the invention. It is to be understood that the drawings are diagrammatic and schematic representations of such example embodiments, and are not limiting of the present invention. Moreover, while various drawings are provided at a scale that is considered functional for some embodiments, the drawings are not necessarily drawn to scale for all contemplated embodiments. No inference should therefore be drawn from the drawings as to any required scale.

In the following description, numerous specific details are set forth in order to provide a thorough understanding of the present invention. It will be obvious, however, to one skilled in the art that the present invention may be practiced without these specific details. In other instances, well-known aspects of transmission systems, including bearings, journals, manufacturing processes, and the like have not been described in particular detail in order to avoid unnecessarily obscuring aspects of the disclosed embodiments.

### A. GENERAL

### Locking CVT

The disclosed embodiments may be usefully employed in connection with a variety of systems and devices, and in a variety of different applications. By way of illustration, but not limitation, embodiments disclosed herein may, in some applications, be employed in connection with a sprocket correction mechanism (examples of which are disclosed in U.S. Provisional Patent Application No. 61/378,875, filed on Aug. 31, 2010, entitled INFINITELY VARIABLE TRANSMISSION WITH SPROCKET CORRECTION MECHANISM) and/or with a driven member, such as a chain (examples of which are disclosed in U.S. Provisional Application Ser. No. 61/307,380, filed on Feb. 23, 2010, entitled CHAIN FOR INFINTELY VARIABLE TRANSMISSION). The embodiments disclosed herein, whether employed with a sprocket correction mechanism and/or driven member, such as a chain for example, or not, may be employed in any vehicle or application whose operation involves the need to transmit power from a source or prime mover to other component(s) and/or system(s). Such vehicles include vehicles configured to operate in and/or on one or more of the following environments: land, water, and air. Further details concerning some example operating environments for the disclosed embodiments are set forth below.

### B. DEFINITIONS

### Locking CVT

1. Continuously Variable Transmission (CVT): A ratio changing machine that allows any speed relationship between the input and the output. The system may be mechanical, electric, hydraulic, or pneumatic. As disclosed herein, the CVT embraces, at least, a variable sheave type mechanical CVT.
2. Variator: A mechanical device that is the active element of a CVT that permits a variable speed ratio between the input and output elements. As disclosed herein, such a device can take the form of a sheave whose width can be dynamically adjusted. Adjustment of the sheave width results in a corresponding dynamic change to the operating diameter of the sheave. That is, the diameter of the sheave can be dynamically changed while an associated driven member, such as a chain or a belt for example, is moving around the sheave. In at least some embodiments, the driven member has a fixed width. In this regard, it should be noted that a drive member, such as a sector gear for example, can be configured with substantially the same width as the chain it drives, or is driven by. Any other component(s) having functionality comparable to such a sheave may alternatively be employed in at least some embodiments of the invention.
3. Traction Drive: A mechanical CVT where the variator translates torque into tension of a driven member, such as a chain or belt for example, primarily through a friction interface between the variator and the driven member.
4. Moon gear: A gear element of a mechanical gear train that is operable to engage a driving or driven member, such as a chain for example, whilst simultaneously orbiting around a center of rotation that is eccentric with the axis of rotation of the gear element. One specific example of a moon gear that may be employed in some embodiments is a sector gear, examples of which are disclosed in U.S. Provisional Patent Application Ser. 61/471,009, entitled SECTOR GEAR ENGAGEMENT DRIVE, filed Apr. 1, 2011; U.S. Provisional Patent Application Ser. 61/480,200, entitled SECTOR GEAR ENGAGEMENT DRIVE, filed Apr. 28, 2011; and, U.S. Provisional Patent Application Ser. 61/568,364, entitled SECTOR GEAR ENGAGEMENT DRIVE AND ADJUSTABLE IDLER/TENSIONER, filed Dec. 8, 2011.
5. Index Line: A radial line defined by the axis of rotation of the moon gear and the axis of rotation of the variator.
6. Index Position: The angular position of the moon gears with respect to the index line that ensures proper meshing with the chain at the relative position of the chain with respect to the variator.
7. Drive Ratio: A relationship between, for example, a sheave type variator and a driven member such as a chain where, during the course of one revolution of the variator, the variator will engage a certain number of chain links, the drive ratio being expressed in terms of the number of links thus engaged. Where the variator takes the form of a sprocket or gear, for example, the drive ratio would correspond to the effective number of teeth. For example, if the chain advances 46.57 links per revolution of the variator, then the drive ratio of the variator would be 46.57.
8. Integer ratio: A drive ratio having a whole, i.e., integer, number of links. For example, 48, 49 or 50.
9. I_{N} ratio: An integer drive ratio where the number of links engaged during the course of one revolution of the variator is wholly divisible by the number of moon gears. When a system is operating at an I_{N} ratio, the moon gears will all be oriented to the same relative angular position with respect to the index line. If there were two, three, four or “N” moon gears for example, then the I_{N} ratio would be noted as I₂, I₃, I₄ or I_{N}. For example, when using an I₃ system, if the lowest integer ratio is 48 links and the greatest is 75, then there are ten I₃ ratios available in the span of the variator, namely, 48, 51, 54, 57, 60, 63, 66, 69, 72 and 75. In this example, and assuming a sheave type variator, 48 is the number of links that are engaged by the variator per revolution when the sheave diameter is at a minimum, and 75 is the number of links engaged by the variator per revolution when the sheave diameter is at a maximum.

### C. EXAMPLE OPERATING ENVIRONMENTS

Turning now to the Figures, consideration is given to aspects of some example operating environments in which one or more of the concepts disclosed herein may be employed. It should be appreciated, however, that the illustrated embodiments are merely examples and that other embodiments are contemplated as being within the scope of the invention.

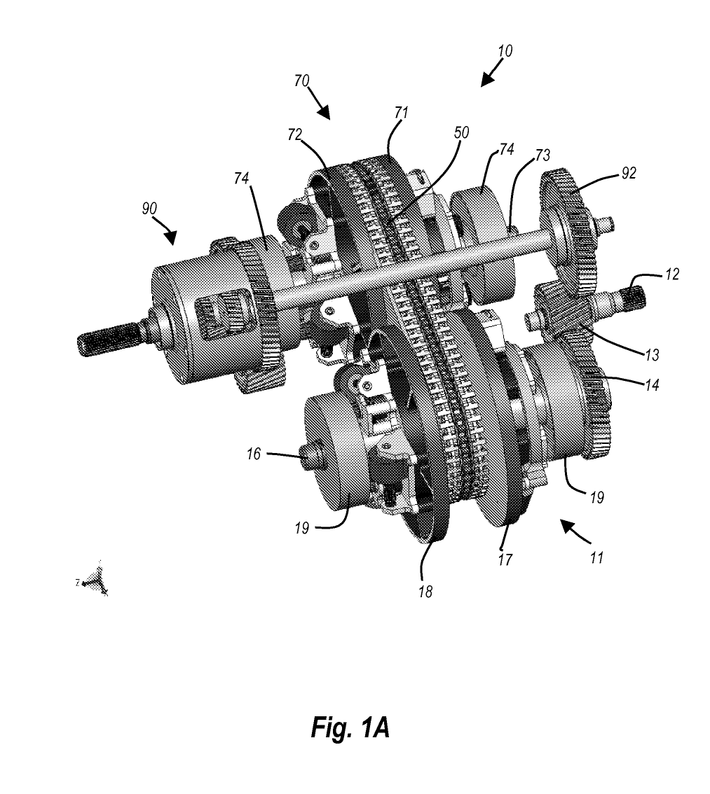

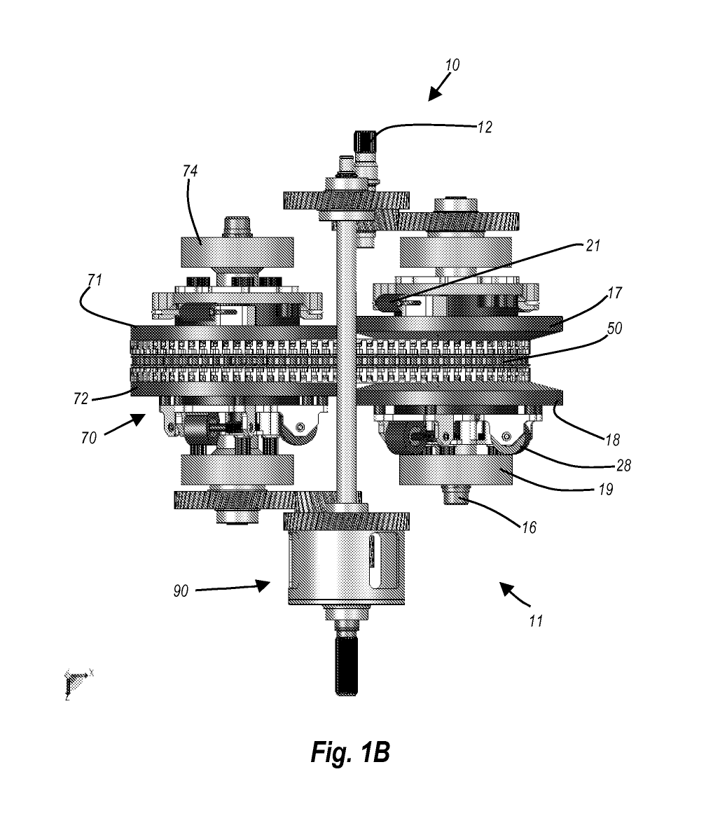

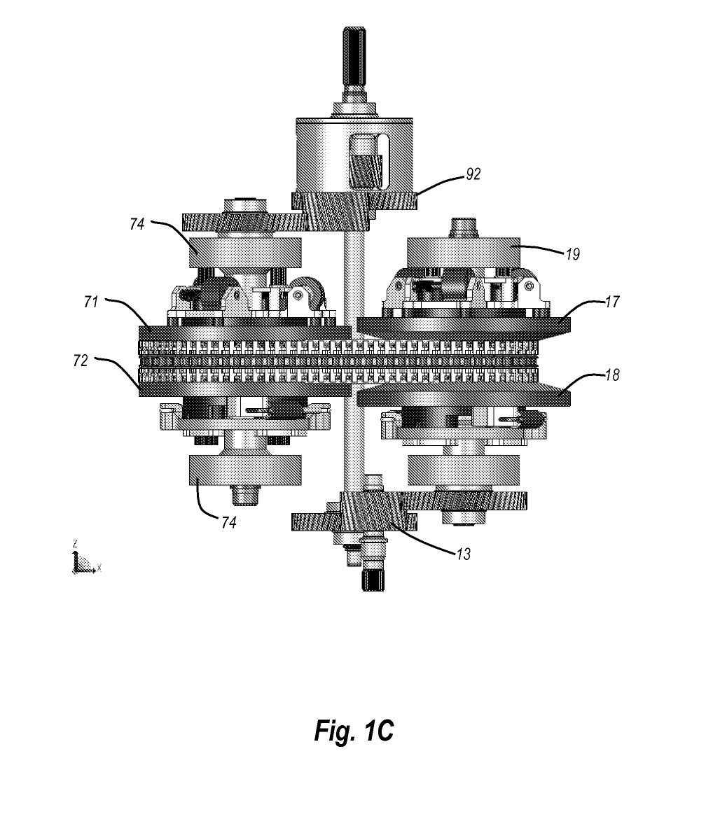

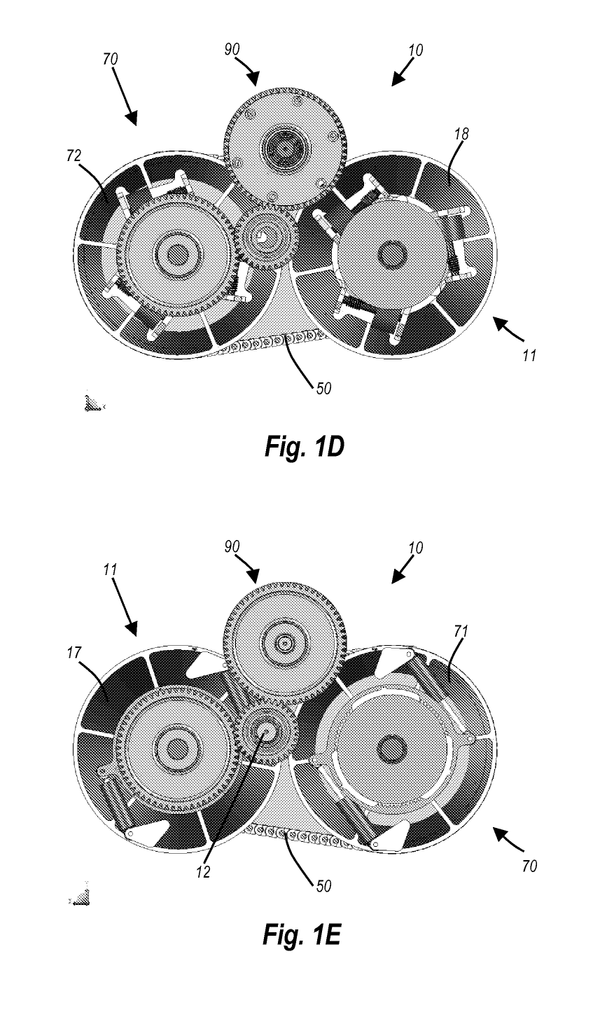

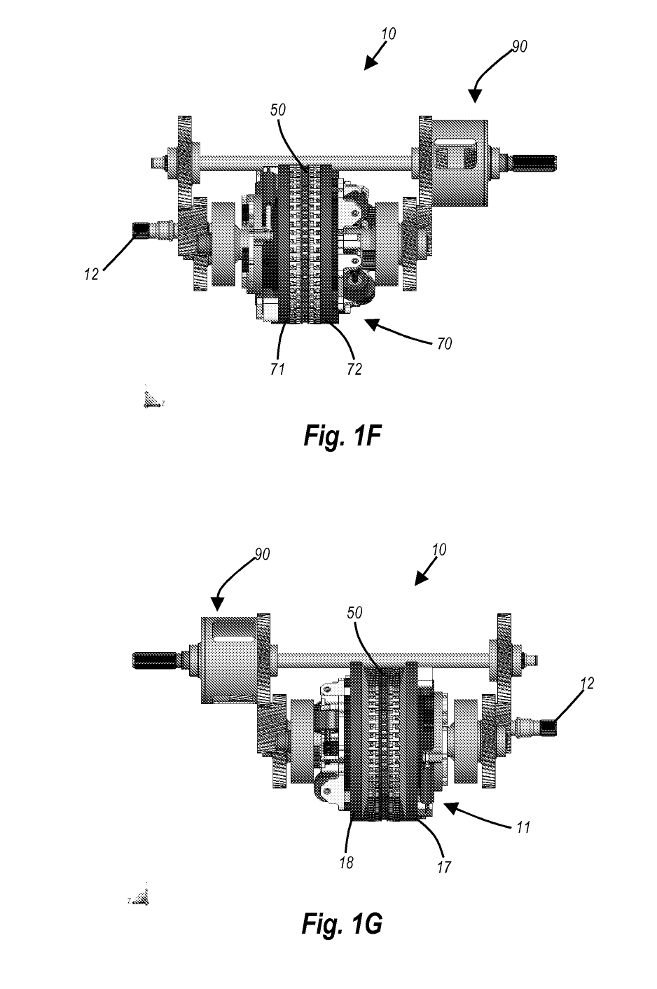

Briefly, power is transmitted through transmission 10 illustrated in FIGS. 1A-1G in a manner that allows infinite variations in gear ratio without disconnection between the power source and the load. Indeed, as described particularly with regard to the Reverse Differential Engaged Neutral, power may be transmitted from a zero velocity output and increased in infinite increments up through a maximum speed that is dependent on the application and various configurable aspects of the invention. Thus, as transmission 10 can start from zero velocity output (which zero velocity can also be an engaged neutral as described hereafter) and move in infinitely variable increments from that starting point, transmission 10 is truly an infinitely variable transmission and not merely a continuously variable transmission.

The ability to start from a zero velocity and move to higher output speeds in infinite increments without disconnection can provide various desired results. For example, heavy machinery or equipment may sit idle on an incline. By changing gear ratios in infinitely small increments, torque spikes may be managed. Moreover, the illustrated transmission 10 further has the capability of operating at a constant velocity—even at neutral—thereby further providing management of torque spikes and facilitating movement of heavy equipment, small automobiles, electric cars, scooters, wind-powered electricity generating devices, and effectively any type of equipment or device in which gear ratio and/or output speed changes are desired.

With regard to the embodiment illustrated in FIGS. 1A-1G, power transmission is obtained by transmitting power received at a transmission input 12, and conveying the same through an input system 11, over a belt 50, and through belt 50 to a power output system 70. Additionally, as described in greater detail herein, transmission 10 may also include a differential system 90 that, for example, can provide the ability to operate at an engaged neutral and thereby provide infinite gear ratio changes and infinite output speed changes, directly from zero output velocity.

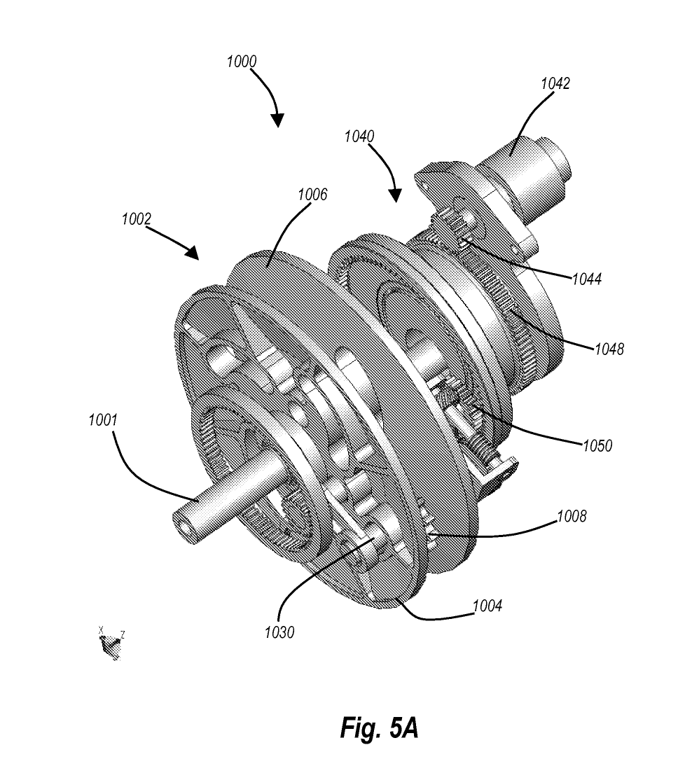

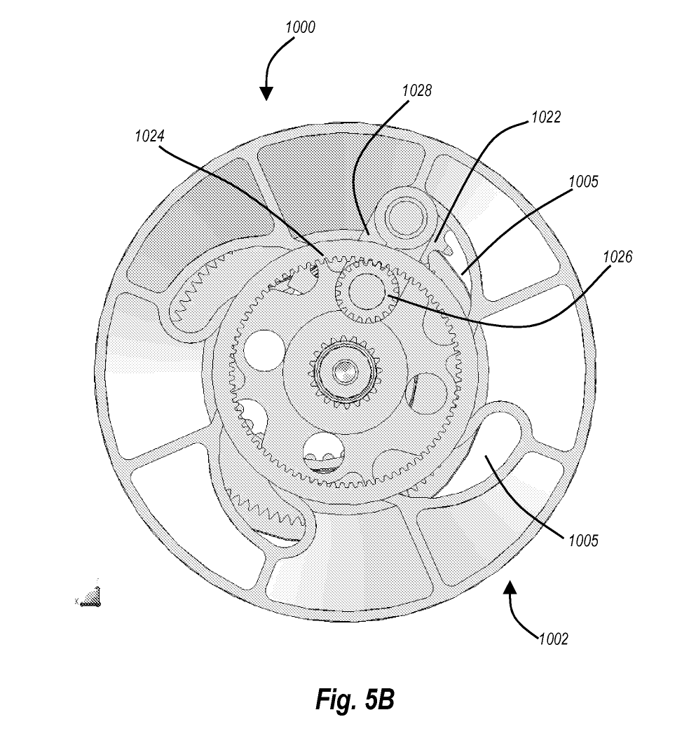

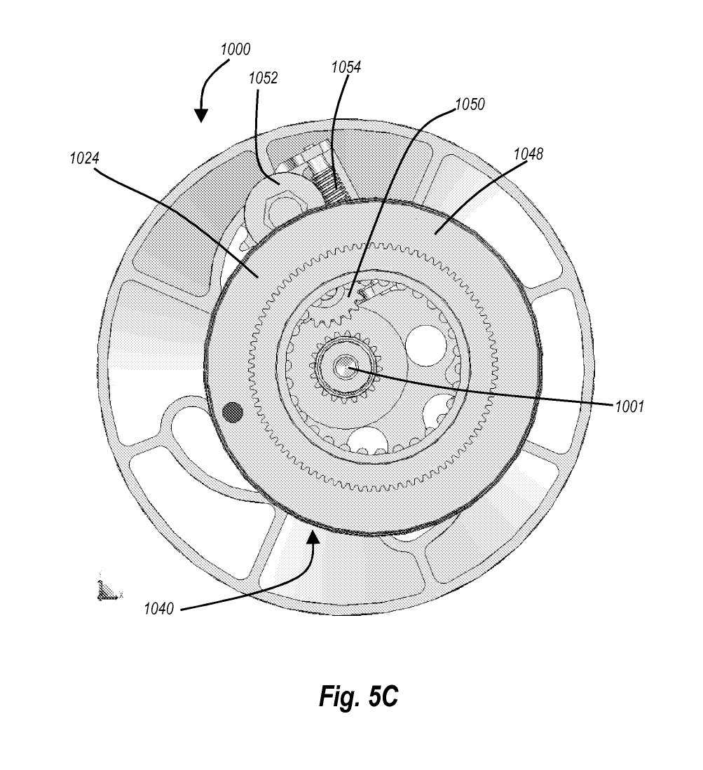

A simplified version of transmission 10 is provided in FIGS. 5A-5C, and shows a similar transmission 100 with various components removed for clarity. Such a description further provides a description of a torque flow path through transmission 100. The torque flow path for transmission 10 in FIGS. 1A-1G is similar or identical in various respects, although transmissions 10 and 100 can be varied as necessary for a particular application.

With respect to transmission 10 in FIGS. 1A-1G, the torque flow path begins as a power input is received at transmission input 12 and is conveyed through input system 11. As transmission input 12 receives the power input, it causes an input gear 13 to rotate. In effect, input gear 13 therefore causes the received input power to be divided along two separate paths. Specifically, input gear 13 is engaged with two additional gears, namely linking gear 14 and transfer gear 92. In effect, linking gear 14 is a part of input system 11 and conveys power received at input 12 through driving members of transmission 10, and ultimately to output system 70. Transfer gear 92, in contrast, sends power input received at input 12 through differential system 90, which is described in greater detail hereafter.

Within input system 11, linking gear 14 is coupled to input shaft 16 such that input shaft 16 rotates as linking gear 14 rotates. Positioned on input shaft 16 is a sheave that is composed of first and second sheave halves 17, 18. The connection between input shaft 16 and linking gear 14 and sheave halves 17, 18 may be, for example, a splined connection. In alternative embodiments, however, linking gear 14 and/or sheave halves 17, 18 may be connected in other manners. For example, in one embodiments, one of sheave halves 17, 18 may be welded or integrally formed with input shaft 16. In this manner, a single one of sheave halve 17, 18 may be movable along shaft 16, although it is not necessary that either of sheave halves 17, 18 be movable. For example, where input system 11 and output system 70 both have sheaves, a sheave on only one of input system 11 or output system 70 may have a movable sheave. Of course, in other embodiments, linking gear 14 or sheave halves 17, 18 may be directly or indirectly coupled to input shaft 16 by way of one or more other gears and/or linkages.

Regardless of the manner of connection between input shaft 16 and linking gear 14 and/or sheave halves 17, 18, as linking gear 14 rotates and causes input shaft 16 to rotate, sheave halves 17, 18 may also be rotated. In this manner, power is transferred through input system to sheave halves 17, 18.

Sheave halves 17, 18 operate as one driving mechanism for conveying power from input system 11 to output system 70. For example, in the illustrated embodiment, chain 50 is positioned between sheave halves 17, 18 and frictionally engages sheave halves 17, 18. Accordingly, as sheave halves 17, 18 rotate, chain 50 also rotates. Further, chain 50 is connected to output system 70 so as to convey power from input system 11 to output system 70. In particular, in the illustrated embodiment, output system 70 also includes a sheave that has two sheave halves 71, 72 that frictionally engage chain 50. Thus, chain 50 engages the sheaves in both the input system 11 and output system 70, to convey power therebetween. Sheave halves 71, 72 are also connected to an output shaft 73. As a result, as sheave halves 71, 72 are rotated by chain 50, output shaft 73 also rotates and provides an output at a particular gear ratio relative to the power input at transmission input 12.

As best illustrated in FIG. 1A, chain 50 may be at different heights on the sheaves represented in input system 11 and output system 70. For example, in the illustrated embodiment, chain 50 is positioned near an external surface of sheave halves 71, 72, but is at a much more interior position on sheave halves 17, 18. This is, of course, merely exemplary, however, and can be varied as necessary to suit any particular application. Indeed, in the illustrated embodiment, sheave halves 17, 18 are configured to move inward (i.e., toward each other along an axis defined by shaft 16) and outward (i.e., away from each other along the axis defined by shaft 16), such that chain 50 can also move radially inward (i.e., toward input shaft 16) and radially outward (i.e., away from input shaft 16). As chain 50 moves in this manner, the gear ratio within transmission 10 can be changed.

To facilitate the movement of chain 50 within sheave halves 17, 18, sheave halves 17, 18 each have an angled interior surface. As described in greater detail hereafter, chain 50 can be positioned against such angled interior surfaces, and chain 50 may also be made of one or more links that have angled outer surfaces generally corresponding to the angle on sheave halves 17, 18. Additionally, while the power transmission component that transfers power from input system 11 to output system 70 is described herein as a chain, in other embodiments it may instead be a belt, or other member.

As will be appreciated by one skilled in the art in view of the disclosure herein, the ability to move sheave halves 17, 18 in-and-out thus provides a range of gear ratios to transmission 10. Furthermore, in some embodiments, sheave halves 71, 72 may be fixed. However, in other embodiments, sheave halves 71, 72 may also be configured to move inward and outward. Indeed, by having the sheaves on input system 11 and output system 70 both move in and out, an even greater range of ratios can be provided.

The range of gear ratios provided can also be modified based on other parameters in transmission 10. For example, the angle of sheave halves 17, 18 and/or the angle on sheave halves 71, 72 can be varied from one embodiment to the next. In particular, when sheave halves 17, 18 move closer together or further apart a specific distance, chain 50 will move radially outward or inward in a plane perpendicular to shaft 16. The distance chain moves radially will, however, be different in embodiments that have different angles on sheave halves 17, 18. For instance, for a specific distance sheave halves 17, 18 are moved, a steeper angle on the sheave halves 17, 18 can cause chain 50 to move a greater distance than would an embodiment that has sheave halves 17, 18 with a lesser angle. The width of chain 50 can also be varied as a wider chain 50 may allow for a greater range of ratios.

The movement of sheave halves can be effected in any suitable manner. For instance, in FIGS. 1A-1G, a sheave spacing actuator 19 is provided for each of sheave halves 17, 18 (and corresponding sheave spacing actuators 74 are also provided for each of sheave halves 71, 72). Sheave spacing actuators 19, 74 may be any suitable device that can facilitate inward and outward movement of sheave halves 17, 18, 71, 72. For instance, in one example, sheave spacing actuators 19, 74 include hydraulic or pneumatic pistons that are journaled around shafts 16, 73. When a gear ratio change is desired, sheave spacing actuator 19 and/or sheave spacing actuator 74 can be activated to exert a force on a portion of a sheave and thereby move sheave halves 17, 18 and/or 71, 72 together, or to reduce an exerted force, thereby allowing sheave halves to separate.

Other types of actuators other than hydraulic or pneumatic pistons can also be used. For example, in another embodiment, a worm gear may be used to advance a compression plate. The worm gear may be actuated by an electronic, mechanical, or electro-mechanical device, and can advance the compression plate to cause a sheave to compress inward, or can be used to back-off the compression plate to cause or allow one or both of the sheave halves to move outward. In still other embodiments, a stepping motor may be used as the actuator 19.

It should also be appreciated that when the sheave control mechanism (e.g., actuators 19, 74) allow the sheaves to separate, it may operate in connection with a tensioning device such that chain 50 follows the spreading sheave to a smaller or larger diameter. When two sheaves are used (e.g., the sheave formed by halves 17, 18 and the sheave formed by halves 71, 72), the second sheave can act as the tensioning device. With such tensioning, when the sheave halves move towards each other, chain 50 effectively climbs outward on the sheave. The angle at which chain 50 climbs outward can be dependent on the sheave as it will follow along the angle on the interior surface of the sheave.

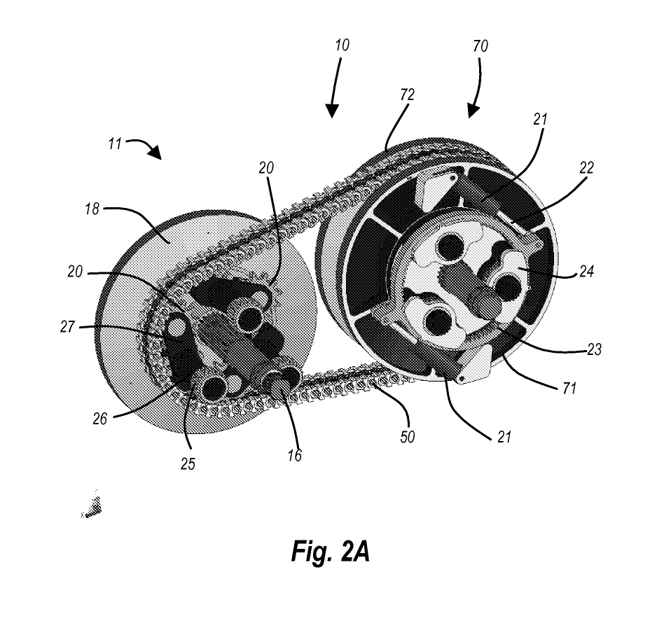

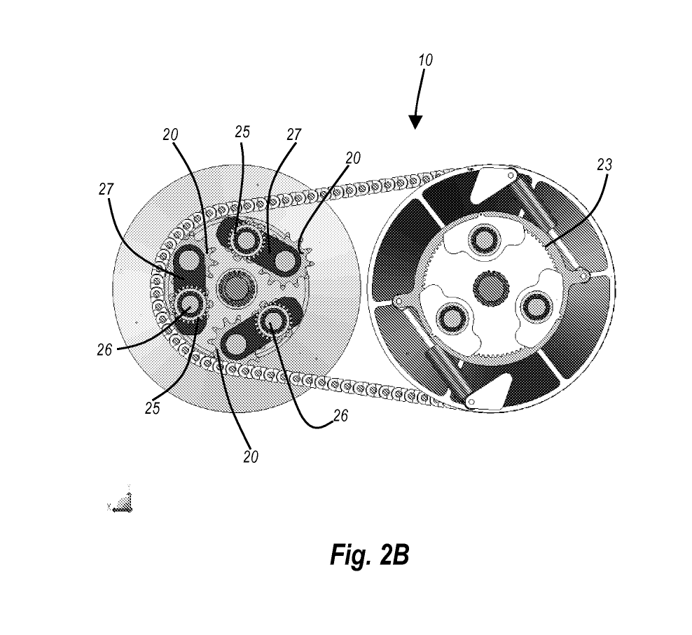

Turning now to FIGS. 2A and 2B, a closer look at the interior of sheave halves 17, 18 is provided. Specifically, FIGS. 2A and 2B illustrated transmission 10 of FIGS. 1A-1G, but with transmission 10 having sheave half 17 and sheave spacing actuator 19 removed, along with various other elements, so as to provide a clear view at the interior of the sheave.

In the illustrated embodiment, chain 50 engages sheave half 18, as well as a plurality of sprockets 20 that are spaced around a central, longitudinal axis of sheave halves 17, 18. Sprockets 20 have a plurality of teeth that are configured to mate with chain 50 and to mesh therewith. In particular, the illustrated embodiment includes three sprockets 20 that are linked to shaft 16, such that when shaft 16 rotates, sprockets 20 orbit around shaft 16. In so doing, each of sprockets 20 will alternately engage chain 50.

For example, sprockets 20 may be angularly spaced at approximately one-hundred twenty degree intervals. When one sprocket 20 orbits to a position that approximately coincides with a portion where chain 50 first engages sheave halves 17, 18, the sprocket 20 may engage chain 50. Such a sprocket 20 can then remain engaged through a portion of its orbital path, and then can disengage at approximately where chain 50 disengages from sheave halves 17, 18. It should be appreciated that the angular interval over which sprockets 20 remain engaged with chain 50 can vary based on the specific design of transmission 10. For example, in one embodiment, each of sprockets 20 may remain engaged for an angular interval of approximately one-hundred eighty degrees, however other intervals are contemplated (e.g., intervals varying from about one-twenty degrees to about two-hundred forty degrees). Additionally, while chain 50 can engage not only sprockets 20 but also sheave halves 17, 18, in other embodiments chain 50 may engage only sprockets 20, or sprockets 20 may be removed so that chain 50 only engages sheave halves 17, 18. Indeed, in an embodiment in which sprockets 20 carry the entire load, sheave halves 17, 18 could potentially be eliminated entirely. It can also be appreciated that, if it is desired for a particular application, chain idlers could be used in concert with chain tensioning devices to keep the engaging and disengaging angles of the chain constant.

By virtue of the orbital motion of sprockets 20 around shaft 16, at least one sprocket 20 can remain in mesh with chain 50 at all times as chain 50 moves around sheaves 17, 18, although it need not be the same sprocket 20 at all times. Further, as will be appreciated in view of the disclosure herein, more than one of sprockets 20 may be engaged at the same time, For example, in the embodiment in FIGS. 2A and 2B, two of sprockets 20 are engaged with chain 50 at the same time.

Additionally, there may be more or fewer sprockets in some embodiments. For example, an embodiment is contemplated in which four sprockets are used, and up to three of such sprockets may be all engaged with the chain at the same time. Of course five or more sprockets may also be used, with varying configurations to allow for one or more than one sprocket to be engaged with the chain at the same time.

Although it is not necessary that sprockets 20 and sheave halves 17, 18 be utilized together in all embodiments, the use of sprockets 20 with sheave halves 17, 18 to drive chain 50 provides various features that may be desirable in various different applications. For example, other transmission systems may employ a belt drive that operates around a sheave. Such systems rely on frictional engagement between the belt and sheave to operate. As with any friction-based system, such transmissions have a certain amount of slip that occurs between the sheave and the belt. This leads to inefficiencies in the system. In the present embodiment, however, the addition of sprockets 20 between sheave halves 17, 18 can eliminate or at least significantly reduce the slippage between chain 50 and sheave halves 17, 18. For instance, sprockets 20 may be connected to a braking system that creates a brake when sprockets 20 are under load (e.g., when sprockets 20 are in mesh with chain 50), so as to resist rotating due to slippage. For instance, a braking system may use a worm gear as discussed hereafter.

Additionally, friction-based systems have heretofore been suitable for some applications, but impractical for other applications for one reason or another. For example, a belt-system that relies entirely on friction between the belt and sheaves has not been shown to be suitable for high torque applications. For instance, a belt may be made of a polymeric material that operates between two sheaves. The higher the torque, the more friction is created. If a large amount of torque is thus applied so that there is a significant torque spike, the frictional creates a large amount of heat that will burn through the polymeric belt. Even if such polymeric materials are combined with composites, metals, and the like, the high heat creates wear on the belt that significantly reduces its useful life. Furthermore, if the polymeric material is replaced with full metal materials, there may be better properties for heat resistance and possibly for heat generation; however, the metal-to-metal contact can result in increased slippage.

The invention described herein may be used in any of the scenarios or embodiments disclosed herein, and can include embodiments in which sprockets 20 are eliminated, so that sheave halves 17, 18 operate as a friction-based system with polymeric, metal, composite, or other belt and sheave materials. Additionally, however, when sprockets 20 are added and used with sheave halves 17, 18, various desirable characteristics can be obtained. For example, even if chain 50 is made of a material that is prone to slippage, sprockets 20 can engage chain 50 and cause chain 50 to continue to rotate around sheave halves 17, 18. Thus, sprockets 20 can operate as an additional drive that may not only reduce slippage, but can also provide an additional input so that friction between chain 50 and sheaves 17, 18 is reduced.

It should be appreciated that while sprockets 20 are illustrated in FIGS. 2A and 2B as being used in connection with sheave halve 17, 18 a similar or identical system may also be used in connection with, or in lieu of, sheave halves 71, 72 of output system 70.

Further, as noted previously, chain 50 may engage sheave halves 17, 18 and orbit therearound, but the diameter of such orbit may be changed as sheave halves 17, 18 move inward and outward, thereby also causing chain 50 to move inward and outward. As will be appreciated, sprockets 20 may thus engage at one position of chain 50, but if chain 50 moves outward from the position illustrated in FIGS. 2A and 2B, sprockets 20 may no longer engage chain 50. Additionally, while sheave halves 17, 18 and chain 50 are described herein as being in frictional engagement, in other embodiments it is not necessary that any significant dynamic friction be present. For example, chain 50 and/or sheave halves 17, 18 may be lubricated in such a manner that chain 50 effectively floats around sheave halves 17, 18. Such effectively frictionless engagement may occur as a result of the addition of oil or another lubricant to the system. For instance, in one example, chain 50 may have an O-ring attached to the links of chain 50. Such an O-ring may trap a lubricant for a time while placed under compression due to the interface of chain 50 and sheave halves 17, 18. The lubricant may create an essentially frictionless surface on which chain 50 can roll for the 60th of a second or so needed to for the particular chain link to enter and exit from engagement with sheave halves 17, 18.

In some cases, it may not be necessary for sprockets 20 to move. For instance, chain 50 may be connected to a sheave of one system (e.g., input or output system), and to one or more sprockets in the opposing system. As such a sheave causes chain 50 to move, chain 50 can still remain engaged with one or more sprockets on an opposing system. With a chain tensioner, chain 50 may thus remain positively engaged and in mesh with a sprocket that prevents slippage along the length of chain 50.

Alternatively, sprockets 20 may themselves move inward and outward, so that they can remain engaged with chain 50 as chain 50 moves inward and/or outward relative to shaft 16. One suitable mechanism for moving sprockets 20 so that they remain in constant engagement with chain 50 is illustrated in FIGS. 2A and 2B. As FIGS. 2A and 2B have various components removed to better illustrate internal components of transmission 10 and input system 11, reference will now be made to various components of output system 70. However, it should be appreciated that the same or similar components are employed on input system 11, but are merely removed in the illustrated embodiment for purposes of clarity.

In FIG. 2A, for example, a pair of adjustment actuators 21 are disclosed. Each adjustment actuator 21 is coupled to sheave half 71, but a similar set of adjustment actuators 21 could be found connected to sheave half 17 (FIG. 1A). As sheave halves 71, 72 move inward or outward, thereby also causing chain 50 to move, actuators 21 can be activated. Actuators 21 have an arm 22 coupled to an adjustment ring 23. Arm 22 can be selectively moved inward or outward. As it moves in such a manner, it causes ring 23 to rotate. For example, outward motion of arms 22 can cause ring 23 to move in a clockwise motion, whereas inward motion of arms 22 can cause ring 23 to move in a counterclockwise motion. Such directions and motions, as well as the operation of actuators 21, are merely exemplary.

Connected to ring 23 are three housings 24 that are spaced at one-hundred twenty degree intervals, and correspond generally to the placement of sprockets 20. Within each housing 24 is an adjustment gear 25 that meshes with gear teeth on the interior of ring 23. Each gear 25 is, in turn, coupled to a shaft 26 that extends inward, toward a respective sprocket 20. On the distal end of shaft 26 is an arm 27 that connects to one of sprockets 20.

Such features, when combined, provide one mechanism that can be used to selectively move sprockets 20 radially inward and outward. Moreover, when such movement is coordinated with the movement of sheave halves 17, 18, it allows sprockets 20 to remain engaged with chain 50 at various radial positions of chain 50, and even throughout changes from one position to another. As a result, the mechanism provides constant, positive engagement between chain 50 and sprockets 20 at not only discrete ratios, but throughout movement from one discrete ratio to another. Thus, chain 50 and sprockets 50 are positively engaged through infinitely small gear ratio changes, and thus through an infinite range of ratios. In other words, transmission 10 not only has constant frictional engagement (e.g., between chain 50 and sheave halves 17, 18 and 71, 72), but there is constant positive engagement (e.g., between chain 50 and sprockets 20) over an infinite range of ratios.

The manner in which the various components provide such engagement can be appreciated from the illustration in FIGS. 2A and 2B. In particular, as ring 23 rotates, the interior teeth engage on adjustment gears 25 rotate. Gears 25 may be coupled by a splined or other connection to shafts 26 which then also rotate. The rotation of shafts 26 will, in turn, cause arms 27 to rotate. As sprockets 20 are connected to arms 27, sprockets 20 will then also rotate.

Additionally, arms 27 and sprockets 20 are configured such that the rotation of arms 27 will move sprockets 20 along a curved path from an innermost position to an outermost position, in infinitely small increments. In this manner, selective activation of actuators 21, can thereby cause sprockets 20 to move inward or outward with the movement of sheave halves 17, 18 and thus facilitates constant engagement between teeth of sprockets 20 and openings of chain 50.

The inventors have previously identified various difficulties encountered when a transmission attempts to maintain constant positive engagement over infinitely small increments. One such difficulty has been termed by the inventors the non-integer tooth problem. In short, the non-integer tooth problem is that as mating gears each move outward in infinitely small increments, there are only certain, discrete points along that path in which the path is equally divisible by the involute tooth profile of the gear teeth. In the case of a chain, the non-integer tooth problem is similar in that as a chain moves outward in infinitely small increments, there are only certain, discrete points along that path in which the path is equally divisible by the profile of the sprocket teeth.

A transmission that is built without consideration of the non-integer tooth problem, and without correction based thereon, may operate even along infinitely variable ratios, but may experience other problems. For instance, teeth may mesh properly at one location (e.g., at a position which is equally divisible into an integer number of teeth), but may not properly mesh at a second location (e.g., at a position which is not equally divisible into an integer number of teeth). There may also be considerable raking between the teeth. In either case, the transmission, although functional, can operate at a lower efficiency and with less desirable wear characteristics.

Transmission 10 as illustrated and described herein, however, can include a correction mechanism that allows for efficient correction of the teeth of sprockets 20. As a result, as chain 50 and sprockets 20 move to provide gear ratios in infinitely variable increments, the teeth of sprockets 20 can be corrected as necessary so as to maintain proper engagement at integer and non-integer locations.

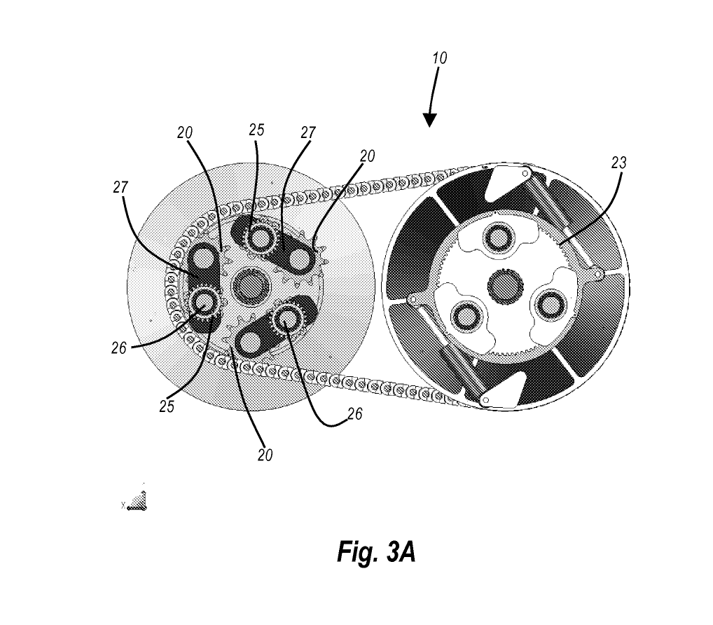

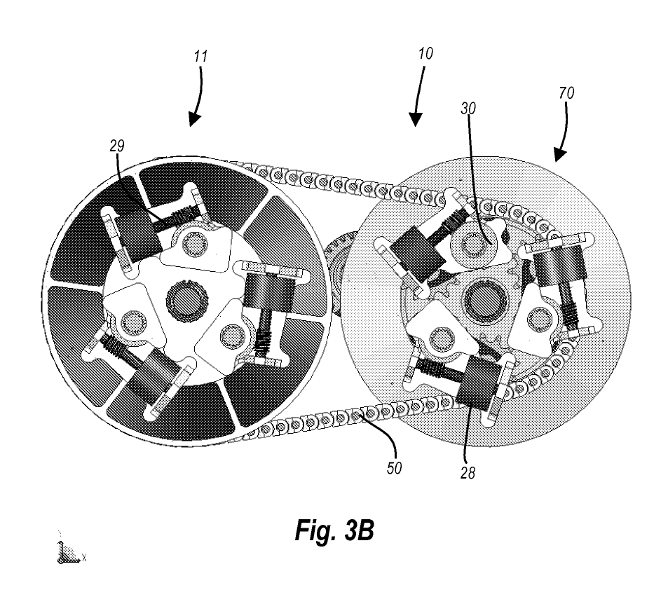

For example, turning now to FIGS. 3A and 3B, another view of transmission 10 is illustrated. Similar to the illustration in FIGS. 2A and 2B, transmission 10 in FIGS. 3A and 3B is illustrated with various components removed so as to provide a better view of an interior of transmission 10. For instance, transmission 10 in FIGS. 3A and 3B is identical to that in FIGS. 1A-1G, but is illustrated without differential system 90, sheave spacing actuators 19, 74 and sheave half 18.

In this illustration, three indexing actuators 28 are illustrated as a part of input system 11. Each of indexing actuators 28 can be selectively activated so as to correct a corresponding sprocket, as necessary. In particular, in this embodiment actuators 28 are each connected to a worm gear 29, and worm gear 29 is maintained in mesh with an indexing gear 30. As actuator 28 is selectively activated, actuator 28 rotates worm gear 29. As worm gear 29 is maintained in mesh with indexing gear 30, rotation of worm gear also causes indexing gear 30 to rotate. Indexing gear 30 may be mounted on an indexing shaft (not shown) which, in this embodiment, runs through a tube 31 that in turn connects to arm 27. Within arm 27 is an indexing drive gear 32 that is mounted to the indexing shaft. Indexing drive gear 32 is also in mesh with sprocket 20.

By virtue of such an indexing mechanism, sprockets 20 can be indexed to remain in alignment both at interval and non-interval locations of chain 50. In particular, as noted previously, worm gear 29 may cause indexing gear 30 to rotate. Such rotation causes indexing shaft and indexing drive gear 32 to rotate. As indexing drive gear 32 meshes with sprocket 30, the rotation of indexing drive gear 32 can also cause sprocket 20 to rotate. Moreover, the rotation of sprocket 20 is controlled based upon the position of sheave halves 17, 18. That is, as sheave halves 17, 18 move in infinitely variable increments either closer together or further apart, actuators 28 can be selectively engaged to rotate sprockets 20 such that even at a non-integer spacing, a tooth of sprocket 20 is in proper position for meshing with chain 50. Such control over the corresponding motions of sheave halves 17, 18, and the activation of actuators 21, 28 may be mechanical and/or may also be computer controlled.

It should also be appreciated that it is not necessary that each of sprockets 20 be actuated at the same time. For example, each sprocket 20 can be indexed separately and/or independently. Indeed, in one embodiment, sprockets 20 are only indexed while they are not under load. More particularly, indexing may occur during the time a sprocket 20 is not engaged with chain 50, and/or transmission may hold-off indexing a sprocket 20 while such sprocket 20 is engaged with chain 50.

Worm gear 29 described in the indexing mechanism thus provides a manner for facilitating and coordinating actuation of actuator 28 and movement of sprocket 20. Worm gear 29 may be replaced with another suitable type of gear; however, in some embodiments, worm gear 29 may also facilitate reduction of slip between input system 11 and chain 50. In particular, even if chain 50 has the tendency to resist movement by sprocket 20 and to slip relative to input system 11, the transmission of torque through sprocket 20 back through actuator 28 can be substantially prevented as worm gear 28 can act as a braking mechanism and resist such movement.

Moreover, while worm gear 29 is the only worm gear illustrated, other gears may be worm gears, helical gears, bevel gears, spur gears, or have any other suitable gear configuration. Additionally, actuators 21, 28 can be any suitable actuator, including at least stepping motors.

### D. REVERSE DIFFERENTIAL WITH ENGAGED NEUTRAL

Now turning to 4A-4C, a transmission 100 is illustrated that is similar to transmission 10 illustrated in FIGS. 1A-3B. Indeed, transmission 100 may be identical to transmission 10; however, in this embodiment various features and components have been removed to facilitate the discussion relative to the transmission of power through transmission 100, including the use of input and output of transmission 100 in providing an engaged neutral, although such is merely an optional component of transmission 10 or transmission 100.

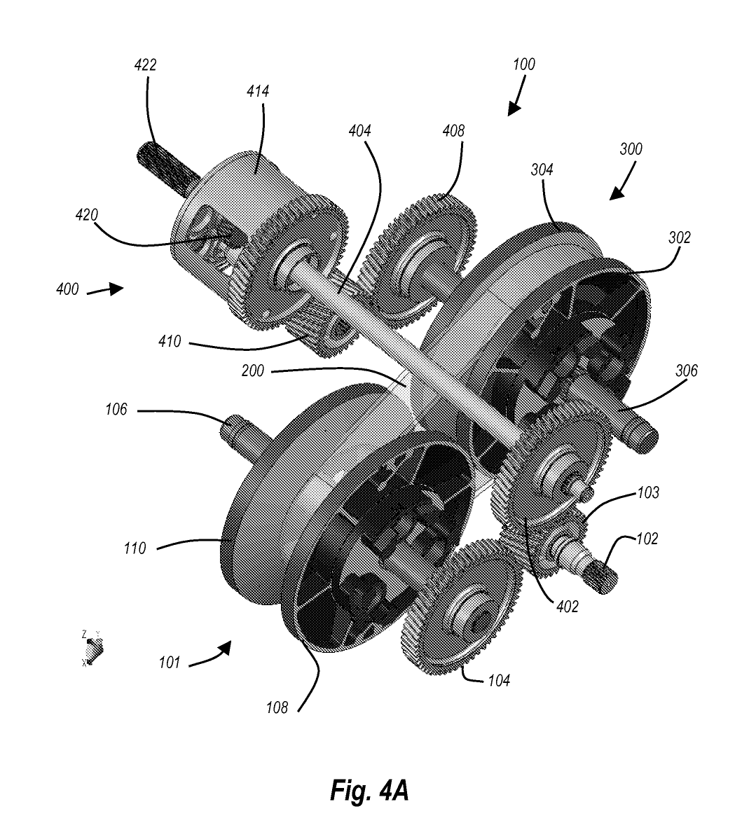

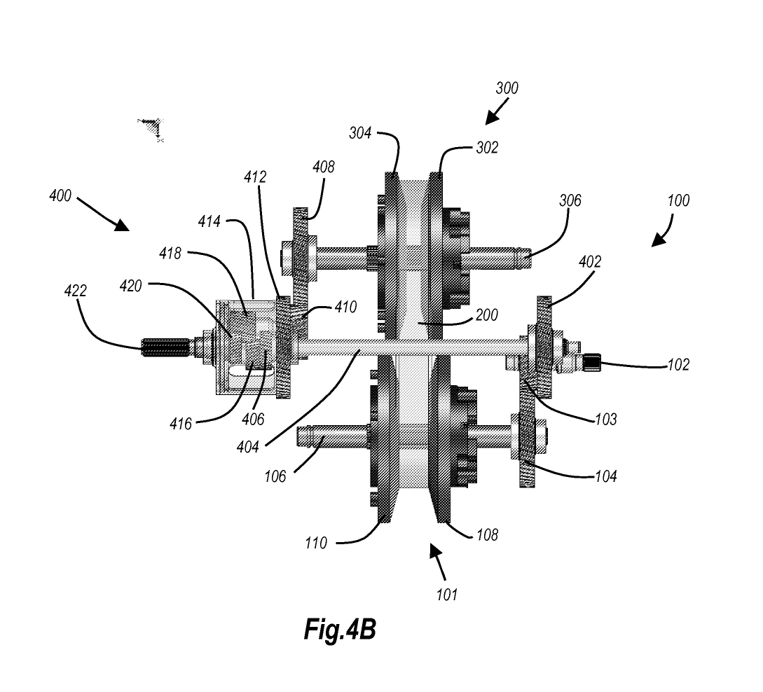

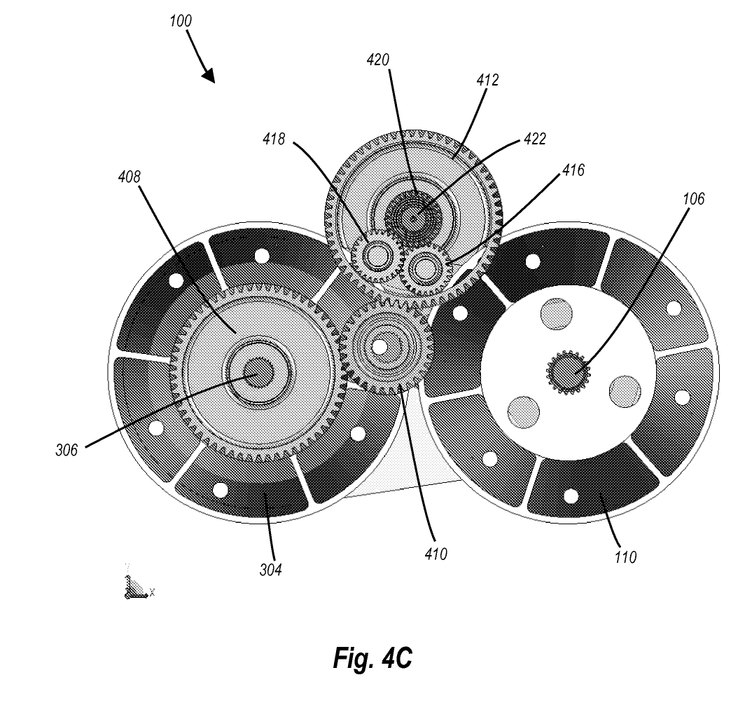

In particular, the illustrated embodiment shows a transmission input system 101 that includes an input 102 that is illustrated in the form of a shaft. As a torque is applied to input 102, a rotational input is provided and transferred through transmission 100 in the manner described herein (including in the discussion of transmission 10). As shown in FIGS. 4A-4C, input 102 may be connected to a differential input gear 103. Differential input gear 103 may, for example, be directly connected to input 102 and can, for example, be integrally formed with the shaft forming input 102, have a spline-connection with such a shaft, or be connected in any other suitable manner. Of course, it is also not necessary that differential input gear 103 be directly connected to input, and differential input gear 103 can, in other embodiments, be indirectly connected to input 102 by, for example, one or more other gears and/or linkages.

As can be seen from the illustrated embodiment, differential input gear 103 is configured to be rotated by input 102. For example, as input 102 rotates in a direction (e.g., clockwise) at a rotational speed, input gear 103 can also rotate in that same direction, at a same rotational speed. Furthermore, differential input gear 103 is positioned, sized, and configured to mate with multiple gears and thereby transfer the rotational input it receives from input 102 to such gears. In this embodiment, differential input gear 103 transfers the input power to two different gears. More particularly, differential input gear 103 mates with an input gear 104 and an input transfer gear 402. The path of the power as transferred along the two separate paths will be discussed in turn.

As differential input gear 103 rotates and engages input gear 104, input gear 104 rotates. In this embodiment, input gear 104 rotates in an opposite direction as differential input gear 103, such that if differential input gear 103 rotates clockwise, input gear 104 will rotate counterclockwise. Input gear 104 may further be connected to shaft 106 in any suitable manner, including connection mechanisms discussed herein. Such a connection therefore allows shaft 106 to rotate as input gear 104 rotates. Also connected to shaft 106 are a set of sheaves halves 108, 110 that shaft 106 causes to rotate. Sheave halves 108, 110 may rotate in either a clockwise or counter-clockwise direction, based on the connection and links within input system 101. In the illustrated embodiment, however, if input gear 104 rotates in a counterclockwise direction, such may cause shaft 106 and sheave halves 108, 110 to also rotate in a counterclockwise direction.

Sheave halves 108, 110 may be directly connected to shaft 106 by a spline-connection or other suitable connection mechanism. In other embodiments, however, sheave halves 108, 110 are connected in other manners, including by way of intermediate gear trains or linkages. Accordingly, it is not necessary that sheave halves 108, 110 rotate in the same direction as shaft 106 and/or input gear 104.

Input system 101 thus receives a power input through transmission input 102 and transfers such power to sheave halves 108, 110 which rotate in response to receipt of such power input. Notably, the rotation of sheave halves 108, 110 is based on the rotation of shaft 106, but such rotation need not match the rotational input of transmission input 102 in magnitude or direction. For instance, inasmuch as power received through input 102 is transferred along one or more gears (e.g., 103, 104) en route to shaft 106, the rotation of sheave halves 108, 110 may be geared up or down relative to input 102. Additionally, based on the links between input 102 and shaft 106, rotation of sheave halves 108, 110 may be in the same or opposite direction as that of input 102. In other embodiments, sheave halves 108, 110 may not be positioned on shaft 106, such that while some embodiments may have the rotation of sheave halves 108, 110 correspond to that of shaft 106, it need not always be the case.

Irrespective of the relationship of the rotation of sheave halves 108, 110 relative to input 102, input system 101 may have power transmitted therethrough transferred to power output system 300 by using an intermediate belt 200. Specifically, belt 200 may be connected to sheave halves 108, 110, such that as sheave halves 108, 110 rotate (e.g., counterclockwise), they also cause belt 200 to rotate in a corresponding direction. The rotation transferred to belt 200 by sheave halves 108, 110 may be caused by friction or in any other suitable manner such as those described herein. For example, as described herein, sheave halves 108, 110 may connect with belt 200 in connection with one or more sprockets (see FIGS. 2A-3B) that also engage belt 200. In this manner, slip between sheave halves 108, 110 can be minimized and efficient power transmission can be obtained.

Belt 200, as it rotates, also engages sheave halves 302, 304 of power output system 300 and sheave halves 302, 304 are thereby caused to have a corresponding rotation. Accordingly, and by way of example only, a counterclockwise rotation of belt 200 may cause sheave halves 302, 304 to also rotate in a counterclockwise direction. Sheave halves 302, 304 also may engage belt 200 in any suitable manner, including by friction and/or with the use of a sprocket. In this manner, belt 200 may be a relatively simple belt which sits between sheave halves 302, 304 or may be a chain that not only engages sheave halves 302, 304, but which also stays positively engaged with one or more sprocket gears. Furthermore, in some embodiments, sheave halves 302, 304 and/or sheave halves 108, 110 may be eliminated entirely.

Sheave halves 302, 304 are in the illustrated embodiment thus rotated by belt 200. Moreover, sheave halves 302, 304 are in this embodiment also connected to an output shaft 306 that rotates in a direction corresponding to that of sheave halves 302, 304. Such connection between output shaft 306 and sheave halves 302, 304 may be in any suitable manner, and may, for example, be a splined connection. Output shaft 306 can thus provide an output from transmission 100 and/or from power output system 300. Furthermore, the power output may be in the form of a rotational output that is geared up or down relative to the power received at input 102 of input system 101. For instance, as described previously, various gears in input system 101 may be used that ultimately provide a gear ratio.

Furthermore, as described elsewhere herein, sheave halves 108, 110 of input system 101 and/or sheave halves 302, 304 of power output system 300, may also provide an additional or alternative gear ratio. More particularly, sheave halves 108, 110 and/or 302, 304 may move inward or outward, thereby changing the path of belt 200. For instance, sheave halves 108, 110 may move closer together, thereby causing belt 200 to move radially outward from the center of sheave halves 108, 110. At the same time, sheave halves 302, 304 may move outward relative to each other, such that belt 200 moves radially inward with respect thereto. In such a manner, sheave halves 108, 110 may cause belt 200 to have a larger radius of curvature than belt 200 has around sheave halves 302, 304. In so doing, each rotation of sheave halves 108, 110 may thus cause more than a single rotation in sheave halves 302, 304, such that output shaft 306 has a greater rotational speed than does shaft 106. An opposite effect may of course also be obtained if the radius of curvature around sheave halves 108, 110 is less than the radius of curvature of sheave halves 302, 304, in which case a single rotation of sheave halves 302, 304 would require multiple rotations of sheave halves 108, 110.

The foregoing example is merely illustrative. In view of the disclosure herein, it should be appreciated that sheave halves may change in a variety of different manners. For example, sheave halves 108, 110 may move to a position that causes belt 200 to have a radius of curvature that is equal to, less than, or greater than the radius of curvature of belt 200 around sheave halves 302, 304. Moreover, in some embodiments, while both sets of sheave halves 108, 110 and 302, 304 may move (e.g., inwardly or outwardly), in other embodiments only a single set of sheave halves may move. Indeed, it is not necessary that both shaft 106 and 306 be connected to sheaves. For instance, in another embodiment, belt 200 may be a chain and sheave halves 108, 110 may be replaced by a sprocket around which belt 200 rotates. In such a case, belt 200 may also move around a chain tensioner that picks up any slack in belt 200 as caused by the changing radius of curvature of belt 200. Additionally, while it is assumed in the illustrated figures that sheave halves 108, 110 are of the same size as sheave halves 302, 304, this need not be the case and the sheave of power input system 101 may be larger or smaller with respect to a sheave of power output system 300.

While shaft 306 may, in some cases, provide the final output of transmission 100, it need not do so in all embodiments, Indeed, in the illustrated embodiment, the output of shaft 306 is further geared through a differential system 400. Differential system 400, in the illustrated embodiment, can provide a variety of features, one of which may be an engaged neutral by which input 102 remains positively connected to output shaft 306 through input system 101, belt 200 and output system 300. Furthermore, as described herein, input 102 may also remain positively engaged with transmission output 422 even when a zero output is provided.

As noted previously, the power received through transmission input 102 may be split along multiple paths. Along one path, for instance, transmission input is passed from input 102 to transfer gear 402 (e.g., through differential input gear 103). In the illustrated embodiment differential input gear 103 mates with transfer gear 402, such that transfer gear 402 rotates as a power input is received at input 102. For example, a clockwise rotation of differential input gear 103 may cause transfer gear 402 to rotate in a counterclockwise direction. Transfer gear 402 may, in turn, be connected to a differential input shaft 404 in any suitable manner, and differential input shaft 404 may also thus rotate as input 102 and transfer gear 404 rotate (e.g., in a counterclockwise direction). Further, while input 102 and differential input shaft 404 may rotate at approximately the same speed, in other embodiments the rotation of input differential shaft 404 may be geared up or down relative to transmission input 102.

FIGS. 4A-4C further illustrate that differential input shaft 404 has a differential input gear 406 connected thereto. In one embodiment, differential input gear 406 is integrally formed with shaft 404 and rotates in the same direction and with the same rotational speed of input shaft 404, but it may also be connected to shaft 404 in other suitable manners (e.g., splined-connection, welded, linked through other gears, etc.).

With continued reference to output system 300 of transmission 100, it can also be seen from FIGS. 4A-4C that an output transfer gear 408 may be connected to output shaft 306 of output system 300. As further illustrated, output transfer gear 408 may mate with a linking gear 410, which in turn mates with a housing input gear 412. For instance, if output 306 rotates counterclockwise, housing input gear 408 may rotate counterclockwise, while linking gear 410 rotates clockwise, and housing input gear 412 rotates counterclockwise. The illustrated embodiment of output transfer gears 408, linking gear 410 and housing input gear 408 is merely exemplary, and other embodiments are possible. For example, in another embodiment housing 414 may directly in-line with output 306 and/or may be secured directly thereto.

As illustrated in FIGS. 4A-4C, housing 414 may also be connected to housing input gear 412, and housing 414 is optionally configured to rotate with housing input gear 412. In this manner, the illustrated gears between output transfer gear 408 and housing input gear 412 are used to transfer the power from power output system 300 to housing 412, so that as a power output is received on shaft 306, housing 412 also rotates. The rotation of housing 414 may be configured in any suitable manner relative to output shaft 306. For example, gears 408, 410, 412 may provide a gear ratio such that housing 412 rotates at a rotational speed less than, equal to, or even greater than the rotational speed of output shaft 306.

Additionally, housing 414 may have multiple gears secured thereto, or therewithin. For instance, a first moon gear 416 may be connected to housing 414 and can engage differential input gear 406. In one embodiment, differential input gear 406 is approximately centered within housing 414, and, as best illustrated in FIG. 4C (which has housing 414 removed to provide a better view of gears 416, 418 and 420 within housing 414), first moon gear 416 may not be centered within housing 414. The positioning of first moon gear 416 in the illustrated embodiment is such that as housing 414 rotates, first moon gear 416 also orbits around differential input gear 406. As differential input gear 406 mates with first moon gear 416, the orbital motion of first moon gear 416 around differential input gear 406 can thus cause first moon gear 416 to orbit. First moon gear 416 may also engage a second moon gear 418 that orbits with housing 414. As first moon gear 416 thus orbits and rotates, it can thus also cause second moon gear 418 to rotate in addition to its orbit provided through housing 414.

A differential output gear 420 is, in the illustrated embodiment, is secured to housing 414 and engages second moon gear 414. In this manner, as second moon gear 414 rotates, it transfers power to differential output gear 420. Differential output gear 420 may, in turn, be connected to an output shaft 422 which may be the transmission output, or may be coupled to the transmission output.

As will be appreciated by one skilled in the art in view of the disclosure herein, differential system 400 can thus provide a differential, but which does not necessarily operate in the same manner as a typical differential such as might be found in an automotive or other power transmission system. For example, in a typical differential in an automotive system, a differential may be used in the final drive on an axle of the vehicle. In such a system, a single input may interconnect with two outputs—one going to either axle on a front drive. The illustrated differential system 400, however, operates in a different manner and, in many regards, opposite the described typical differential.

Specifically, the illustrated embodiment includes two inputs and a single output. Specifically, a first input to differential system 400 is provided from transmission input 102 and ultimately conveyed into housing 414 through shaft 404 and differential input gear 406. A second input to differential system 400 is provided from output shaft 306, and is applied directly to housing 414.

In the described manner, there may thus be two different inputs provided to differential system 400, and the two inputs may be combined into a single output. Additionally, based on the directions and magnitudes of such inputs, they may be additive and/or subtractive within differential system 400. For example, it will be appreciated that through gearing, input from transmission input 102 can be provided and transferred such that differential input gear 406 rotates in a first direction (e.g., counterclockwise). Through appropriate gearing, the rotation of output shaft 306 may also be transferred to housing 414 so that housing 414 rotates in the same direction (e.g., counterclockwise), although input gear 406 and housing 414 may, in other embodiments, provide inputs that are in opposite directions. In the illustrated system, the variations to the respective magnitudes of the rotational inputs can ultimately provide a variety of different outputs at output 422, including a reverse, neutral, drive and overdrive for transmission 100. Thus, two inputs can combine to provide a clockwise or counterclockwise rotation, or even to provide no output.

More particularly, as transmission input gear 406 rotates, housing 414 may also be rotating and causing first moon gear 416 to orbit around transmission input gear 406 in the same direction. At mating gears, the velocity of the gear teeth at the point of engagement must be equal as to direction and magnitude. Further, the velocity of gear teeth is related to the rotational and/orbital motion by the equation V=rω, where V is the linear velocity, r is the radius of rotation at the point of engagement, and w is the angular velocity.

With continued reference to FIGS. 4A-4C, it should be appreciated that by varying the relationship between the rotational speed inputs at housing 414 and differential input gear 406 (e.g., by varying gear ratios between input system 101 and output system 300), a wide variety of outputs can be received. Moreover the varied outputs can be obtained while transmission 100 maintains engagement between all drive and driven members, and can result in forward, reverse, and even neutral/stopped conditions with such engagement. Moreover, transmission 100 may even operate at a constant input velocity, and such differing outputs can be obtained by varying the output on shaft 306 relative to the constant input at input 102.

It should be appreciated that the foregoing is merely exemplary, and that other configurations can exist. For instance, in some embodiments, second moon gear 418 may be eliminated entirely, or additional moon or other gears can be provided. Furthermore, gears within housing 414 may be different sizes such that the above relationship between the output and two input rotational velocities can change. In still other embodiments, the input may even be disconnected and allowed to rotate freely, or held with zero internal rotation. In still other embodiments, input gear 406 and housing 414 may receive inputs in opposite directions. Additionally, while only a single first moon gear 416 is illustrated, there may be additional first moon gears 416 that each engage differential input gear 406, thereby transferring the torque among multiple gears. Naturally, there may also be additional second moon gears 418, or other gears within differential system 400.

Accordingly, the relative rotational motions, and the magnitudes thereof, of transmission input gear 406 and first moon gear 416 can thus with or against each other, such that the rotational speed of first moon gear 416 (as opposed to the orbital motion of first moon gear) can be in a clockwise or counterclockwise direction.

One feature of the disclosed differential system 100 is the ability to start with engagement from a dead stop. For instance, a vehicle with a high torque engine (e.g., a semi-tractor trailer) may be stopped in an engaged neutral on a road with a steep incline. With the above described differential system 400, such a vehicle can maintain engagement while moving the load forward in infinitely small increments. In particular, infinitely small increments of change can be used to cause the vehicle to move, such that there is little to no rollback when starting the movement, and the infinitely small increments of change can also reducing a torque spike when engaging the engine.

In all regards, the embodiment described above with respect to transmission 100 is illustrative, and one skilled in the art will appreciate that various alternatives and/or additional components may be utilized. In some regards, for example, gears may be removed or added to provide additional gear ratio changes, and/or to link inputs or outputs to other components. In one embodiment, for instance, housing 414 may be directly coupled to output shaft 306 and/or positioned in-line therewith. Additionally, it will be appreciated that the various gears and components described with regard to transmissions 10 and 100 may be positioned on bearing surfaces. For example, first and second moon gears 416, 418 and/or differential output gear 420, may have bearing surfaces interfacing with housing 414 to thereby allow rotation within housing 414.

### E. EXAMPLE ALTERNATIVE EMBODIMENTS

As noted herein, there are various alternative embodiments that may be used for any of the components, systems, sub-systems, or assemblies illustrated and/or described herein, and which are suitable to replace or supplement the specific embodiments disclosed herein. In this section, various alternative embodiments will be briefly provided to illustrate the wide-ranging differences that can be included with a transmission system as disclosed.

FIGS. 5A-5C, for example, illustrate an embodiment of a sheave-and-belt transmission 1000 according to another embodiment of the present invention. In the illustrated embodiment, only a portion of transmission 1000 is illustrated in order to more clearly view the various components of the system (e.g., the illustrated portion may generally represent a power input and/or power output system). Transmission 1000 may, however, operate on the input and/or output sides of a transmission.

In some regards, transmission 1000 operates in a manner similar to transmissions 10, 100 described herein. For example, transmission 1000 includes a sheave 1002 that includes two halves 1004, 1006. Sitting on sheave 1002 may be a belt or chain (not shown) which then connects to another drive or driven member. For instance, transmission 1000 may be an input system and drives the belt or chain as it connects to a sprocket or other sheave on an output system. The belt or chain may also connect to a driven sprocket as well as a chain tensioner to account for changes to the belt or chain by virtue of movement of sheave 1002.

In the illustrated embodiment, transmission 1000 includes one or more sprockets 1008 which run between sheave halves 1004, 1006. As with transmissions 10, 100 described previously, sprockets 1008 may move radially inward and outward to adjust position as sheave halves 1004, 1006 are moved together or apart. With particular regard to FIG. 5B, an adjustment mechanism 1040 is illustrated. In FIGS. 5A and 5B, only a single sprocket 1008 is illustrated; however, transmission 100 is equipped to have four sprockets. The number of sprockets 1008 is variable, however, and can be changed to suit a particular application.

In FIG. 5B, a ring gear 1024 is illustrated. Ring gear 1024 is further connected to a linking gear 1026, although there may be one linking gear 1026 for each sprocket 1008. When sheave 1002 is moved, it may also become necessary or desirable to move sprockets 1008. As a result, to coincide with the movement of sheave 1002, ring gear 1024 can be rotated. Rotation of ring gear 1024 may cause linking gears 1026 to rotate as well. Linking gears 1026 are attached to an arm 1028 which in turn attaches to a shaft 1030. Rotation of linking gears 1026 causes arm 1028 to rotate. Arm is positioned within a channel 1005 of sheave half 1004. The rotation of arm 1028 causes movement of shaft 1030 to move along the arc path provided by channel 1005. Sprocket 1008 is attached to shaft 1030, so that as shaft 1030 moves along channel 1005, sprocket 1008 moves radially inward and outward.

In other cases, ring gear 1024 may even be eliminated entirely. For example, in some embodiments, sheave 1002 may have channels formed therein along which shafts 1030 move. Optionally, shafts 1030 can be fitted within channels 1005 in such a way that movement of sheaves 1002 automatically causes shafts 1030 to float within channels 1005.

FIGS. 5A and 5C further illustrate exemplary components of an indexing system 1040 that can rotate sprockets 1008 as necessary to ensure a suitable engagement as sheaves 1002 and sprockets 1008 move to produce different gear ratios. For example, indexing system 1040 includes an actuator 1042 that can cause an outer gear 1044 to rotate. Outer gear 1044 engages a indexing ring gear 1048 that rotates. An interior gear 1050 may be positioned within ring gear 1048 (although there may be one interior gear 1050 for each of sprockets 1008). Notably, in this embodiment, and as best shown in FIG. 5C, indexing ring gear 1048 may be positioned off-center relative to shaft 1001 on which sheaves 1002 are positioned. As a result, as sheaves 1002 and shaft 1001 rotate, the various interior gears 1050 may alternately engage ring gear 1050. As they do so, they may engage a worm driving gear 1052 that then operates with a worm gear 1054 to index a sprocket 1008 in a manner similar to that previously described. For instance, worm gear 1054 may cause sprockets 1008 to rotate while they are not under load from the chain that moves around sheave 1002.

One aspect of the embodiment in FIGS. 5A-5C, and which can be applied equally to all embodiments disclosed herein, is that machines themselves provide intelligence. For example, in the illustrated system, the off-center position of indexing ring gear 1048 relative to shaft 1001 facilitates a mechanical intelligence whereby each of sprockets 1008 is automatically adjusted, so that the mechanism corrects itself.

Moreover, the use an eccentric or off-center gear is not the only manner in which mechanical intelligence may be utilized in this regard. For example, in another example, there may be multiple chains running on multiple sheaves. For example, four chains may be positioned on four sheaves. During operation, only one sheave may be carrying the load.

Additionally, in another embodiment a differential is used as a mechanical intelligence device. For instance, with a differential, there may be two inputs that are related to each other by the differential and used to produce an output. As the inputs change relative to each other (e.g., by changing the distance between sheave halves so that the chain moves radially), a corresponding change will be obtained as an output of the differential. More specifically, as rotational size changes, there may be a proportional change in the rotational output of the differential. In knowing that the drive shaft will turn a certain amount with each rotation, by knowing the proportion of change in the rotational motion of the drive shaft, this can be tied back into the sprockets to automatically adjust the sprockets for engagement at non-integer locations. Thus, a motor or actuator may not be necessary for sprocket correction.

Additionally, while the above examples illustrate correction of the sprockets, in other embodiments the chain itself may be corrected. For example, a roller may be placed outside the chain, and can then adjust the chain position to engage even at non-integer locations.

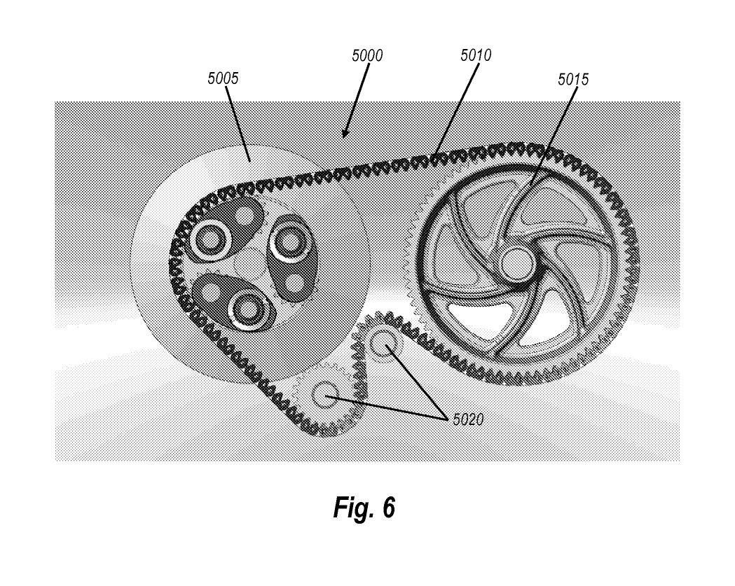

FIG. 6 illustrates a side view of an example transmission 5000 according to some embodiments of the invention. In the illustrated embodiment, a single sheave 5005 is used (and illustrated with half of the sheave missing so as to provide a more detailed view of the interior of the transmission). In this embodiment, one side of chain 5010 loops around sheave 5005, while the other end of chain 5010 loops around a sprocket 5015. As further illustrated in this embodiment, one or more chain tensioners 5020 can be included to pick-up any slack in chain 5010 as sheave 5005 adjusts in size.

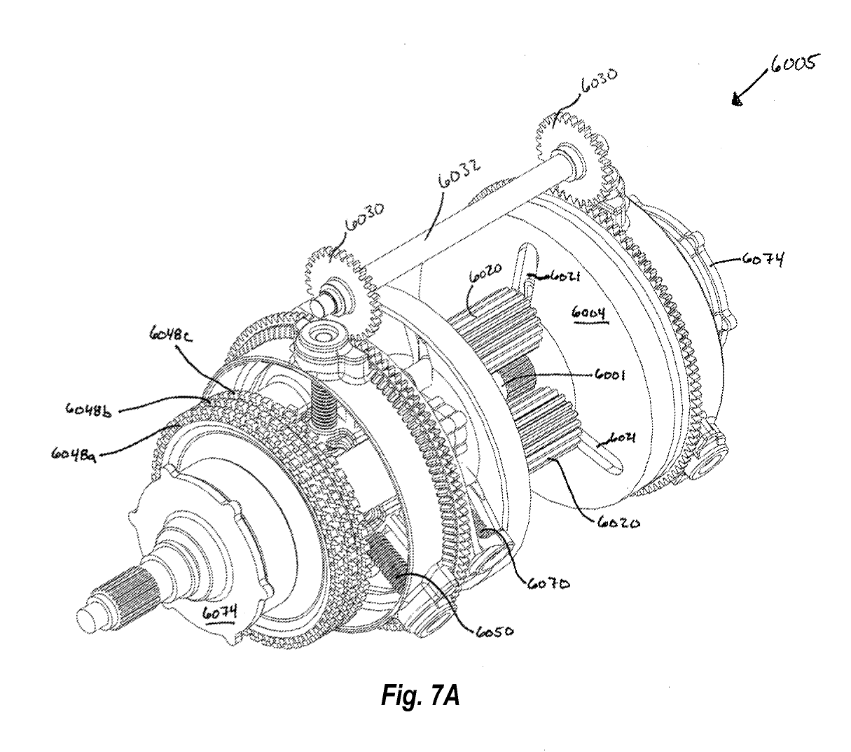

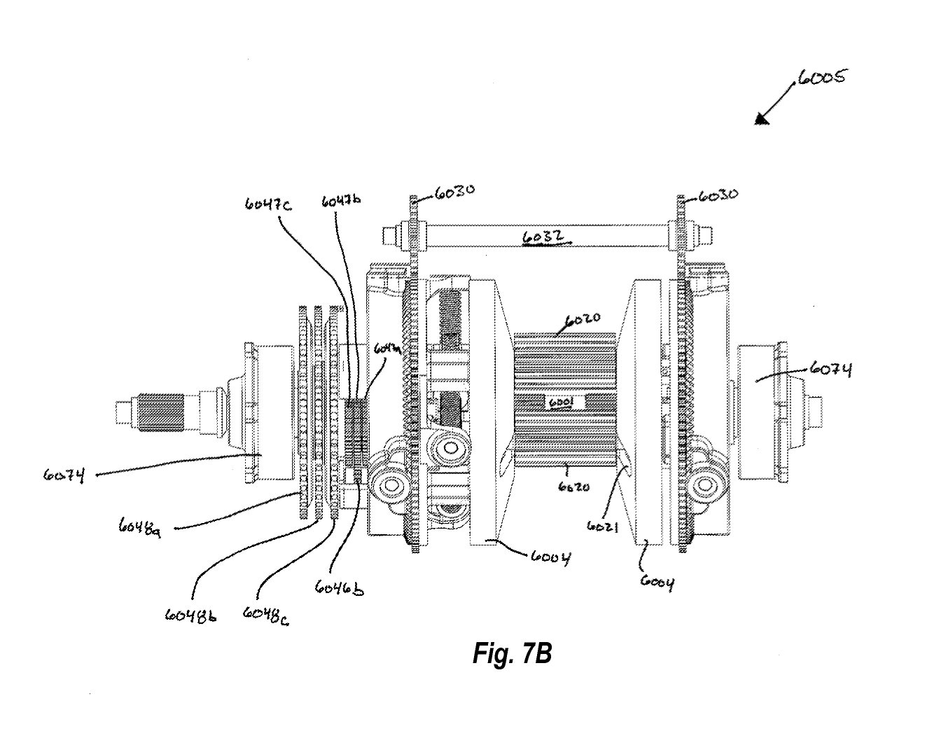

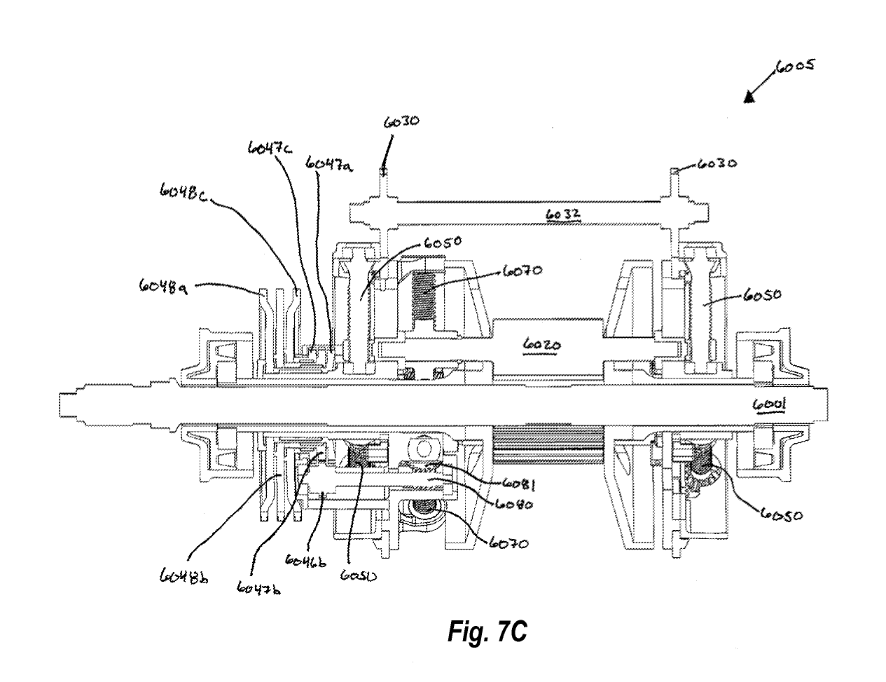

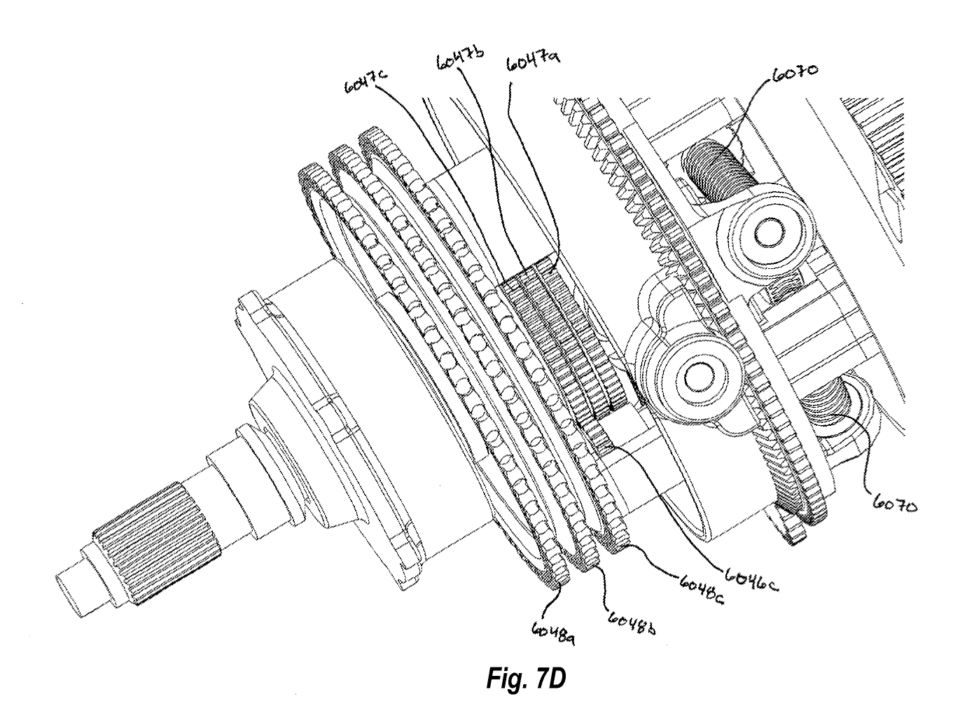

Turning now to FIGS. 7A-7D, another example embodiment of aspects of a transmission system are described. In particular, FIGS. 7A-7D illustrate an example sheave assembly 6005 usable with transmission systems as described herein. For example, sheave assembly 6005, or portions thereof, may replace or supplement power input system 11 and/or power output system 70 of FIGS. 1A-3B, input system 101 and/or output system 300 of FIGS. 4A-4C, the illustrated portion of transmission 1000 of FIGS. 5A-5C, or sheave 5005 or sprocket 5015 of FIG. 6.

Sheave assembly 6005 of FIGS. 7A-7D includes various components operating similar to components described elsewhere herein. Accordingly, to avoid obscuring additional aspects of sheave assembly 6005, such components will generally not be described, as a suitable discussion is found above. Rather, additional detail will be give to additional and novel components in this embodiment.

In the illustrated sheave assembly 6005, and similar to other embodiments herein, a shaft 6001 may pass through sheave assembly 6005 and have attached thereto two sheave halves 6004. Sheave halves 6004 are, in this example, attached to shaft 6001 using a splined connection on shaft 6001, although other types of connections may also be used. The splined connection on shaft 6001 can allow shaft 6001 to rotate and also generate a corresponding rotation on sheave halves 6004; however, as sheave assembly 6005 may also operate as an output assembly, sheaves halves 6004 may provide the input and cause shaft 6001 to rotate.

In some embodiments, and as described herein, sheave halves 6004 may be movable axially along shaft 6001. Such axial movement may, for example, allow a chain or belt riding on sheave halves 6004 to move radially inward and outward relative to shaft 6001, thereby changing a gear ratio of the transmission. To facilitate movement of sheave halves 6004, two hydraulic actuators 6064 are provided on shaft 6001 and can use fluid pressure to compress sheave halves 6004 together, or such fluid pressure can be backed off to allow sheave halves 6004 to separate.

As also disclosed previously herein, between sheave halves 6004 there may be one or more indexing gears 6020 configured to engage with a chain positioned around sheave halves 6004. Indexing gears 6020 can engage the chain and act to prevent or reduce slippage of the chain on sheave halves 6004. The number of indexing gears 6020 may be varied, although in one embodiment, three indexing gears 6020 are spaced around shaft 6010. In other embodiments, more or fewer indexing gears 6020 may be used.

Inasmuch as sheave halves 6004 can move and cause a corresponding chain to move radially inward or outward, indexing gears 6020 may also move radially inward and outward relative to shaft 6001. In the illustrated embodiment, this may be accomplished using an indexing system that includes a slot 6021 and worm gear 6050. Indexing gears 6050 may rotate around a shaft and worm gear 6050 may be directly or indirectly connected to an electric, hydraulic, or mechanical actuator (not shown). As such actuator causes worm gear 6050 to rotate, a carrier attached to the shaft on which indexing gears 6004 rotate may move upward or downward, depending on the direction of actuation on worm gear 6050. The shaft may thus move radially inward or outward through slot 6021.

As disclosed previously, the radially outward or inward motion of indexing gears 6020 may be along an arcuate path. In the illustrated embodiment in FIGS. 7A-7D, however, slot 6021 is generally linear, so it will be appreciate that the radial translation of gears 6020 may also follow a generally linear path. Indexing gears 6020 generally move along slot 6021 when not under load, and can each move independent of each other, or may move collectively. Further, as shown in FIGS. 7A-7D, indexing gears 6020 may move along slots in both sheaves 6004.

To link the movement of indexing gears 6020 such that the shaft is moved proximate both sheaves, the illustrated example embodiment includes a cross-over shaft 6032. Cross-over shaft 6032 is coupled to a pair of linking gears 6030 that may in turn engage a drive gear to drive worm gears 6050, or may directly drive worm gears 6050. A single cross-over shaft 6032 is illustrated; however, one may be included for each of indexing gears 6020. For example, multiple cross-over shafts 6032 may be included to separately and independently move indexing gears 6020, although a single cross-over shaft 6032 may be linked to collectively cause indexing gears 6020 to translate. For example, a single cross-over shaft 6032 may be fixed, such that it does not orbit around shaft 6001. As a result, as sheaves 6004, indexing gears 6020 and worm gears 6050 rotate around shaft 6001, the control mechanism interacting with worm gears 6050 can alternatively engage cross-over shaft 6030 (e.g., through linking gears 6030) to index their position.

By translating indexing gears 6020 as sheaves 6004 move, indexing gears 6020 may remain in constant contact with the associated chain, and can act as a non-slip mechanism. The translation movement of indexing gears 6020 may be referred to herein as “indexing”, as gears 6020 are indexed to correspond to the radial position of the chain on sheaves 6004. Another mechanism, referred to herein “correcting” and as discussed hereafter, may relate to the rotational movement of indexing gears 6020 to align teeth of indexing gears 6020 with pockets of the chain. The terms “indexing” and “correcting” may sometimes be used interchangeably; however, “indexing” generally relates to the radial movement of indexing gears 6020 relative to shaft 6001, while “correcting” relates to the rotational movement of indexing gears 6020 about their own axes.

With regard to correction of indexing gears 6020, illustrated in FIGS. 7A-7D is a correction mechanism usable to rotate indexing gears, and to thereby advance and/or retreat teeth of indexing gears 6020 as desired for alignment with the chain. By way of explanation, tooth profiles are generally calculated and determined based on a radius (e.g., pitch radius). As the chain translates radially inward and outward, that radius changes which ultimately causes traditional calculations to produce different desired gear teeth profiles at each location. Inasmuch as indexing gears 6020 can have a fixed size, the changes may then be accounted for in a different manner—namely by correcting the rotation of the indexing gears. Typically, such correction will be performed while indexing gears 6020 are not under load (e.g., not engaged with the chain), although in other embodiments it may be desired to correct motion while under load.

In the illustrated embodiment, indexing gears 6020 are corrected by a correcting mechanism/correction means that includes worm gears 6070. Specifically, the example embodiment includes an indexing gear 6020 that is connected, at least indirectly, to a worm gear 6070 and, as the worm gear 6070 rotates, a kinematic transfer of power causes indexing gears 6020 to rotate. For instance, as shown in FIG. 7C, worm gears 6070 may be coupled to a set of one or more driving gears 6080, 6081 that cause worm gear 6070 to rotate. As worm gear 6070 rotates, a transfer gear 6070 that is linked to the shaft of indexing gear 6020 rotates, thereby also rotating indexing gear 6020.

The particular manner of correcting indexing gears 6020, as described and illustrated herein, is merely exemplary. Moreover, the manner of controlling such a correction mechanism may also be varied in any suitable manner. For example, a controller may be included that mechanically, electrically, hydraulically, or otherwise controls operation and correction of indexing gears 6020. In the illustrated embodiment, for instance, a hydraulic control system is illustrated.

In the hydraulic control system, a set of three reversing turbine disks 6048a-c are illustrated. Each reversing turbine disk 6048a-c of the illustrated embodiment may rotate around a shaft and can move in a forward and reverse direction, which can ultimately be transferred to the indexing gears 6020 so as to advance or retreat the teeth of indexing gears 6020. For instance, as best shown in FIG. 7C, each of turbine disks 6048a-c is linked to an interior main gear 6047a-c. Specifically, turbine disk 6048a links to interior main gear 6047a, turbine disk 6048b links to interior main gear 4047b, and turbine disk 6048c links to interior main gear 6047c. Further, each of interior main gears 6047a-c may also link to a correction drive gear 6046a-c corresponding to one of indexing gears 6020. In FIG. 7C, for instance, correction drive gear 6046b engages interior main gear 6047b. As turbine disk 6048b thereby rotates, and causes interior main gear 6047b to rotate, correction drive gear 6046b may also rotate and transfer power to driving gears 6080, 6081 (e.g., along a shaft) to ultimately control and correct the rotation of indexing gears 6020. In the illustrated example embodiment, each of the three turbine disks 6048a-c can correct one of indexing gears 6020. Thus, any indexing gear 6020 can be corrected independent of any other indexing gear 6020.

It should be appreciated in view of the disclosure herein, that any number of control and actuation mechanisms and means can accordingly be used to adjust a transmission according to the present invention. For example, one actuator may move sheave halves 6004 axially, while a separate actuator indexes indexing gears 6020 by causing them to translate radially, and while a still other actuator corrects gears 6020 by causing them to rotate. In some embodiments, some or all actuators may be combined together. For instance, radial translation of indexing gears 6020 may be configured to cause a correcting rotation. In some embodiments, the correcting rotation may be all or a part of the needed correction motion.

One aspect of the embodiments disclosed herein are further the ability to control and/or minimize vibrational aspects associated with the disclosed transmissions. For example, in a belt drive system, a friction belt stretches as it unwraps off a sheave, as a result of the tension in the belt. According to similar principles, a chain drive system also stretches the chain as the chain becomes disengaged and experiences the tension in the chain. Notably, however, the chain may stretch link-by-link, as each link becomes disconnected from each tooth. The full stretching may not be instantaneous and some stretching may occur as the chain wraps around the sheaves; however, a large portion of the stretching may still occur at disconnection between a chain link and a carrying sprocket/sheave.

As a result of the cycling of the chain and the continual stretching of the links of the chain, a vibration may be produced. For example, if there are three sprockets or indexing gears carrying the chain, the chain may stretch back to each other sprocket, such that vibration may occur as the angular relationship in the chain changes three times per revolution. The embodiments herein can, however, provide control to correct or minimize such vibration. For example, as noted herein, a transmission may include a correction mechanism to rotate the indexing gears. By correcting the indexing gears and rotating them about their axes, the transmission can be adjusted to control at least the period of the vibration and reduce or minimize the effect of such vibration.

In some cases, the correction of the indexing gears to control the vibration may result in a small amount of slip occurring between the chain relative to the sheave. Such slip, while not necessarily desirable in itself, may nonetheless be desired on a system perspective as the slip can be managed and may help control unwanted vibration. Further, the amount of slip can be defined relative to the stretch of the chain to limit its effect. Thus, advancing and/or retreating the sprocket may be of significant use in controlling vibration of a transmission, and the forward/backward control of the rotation of the sprockets permits the sprocket to become loaded during rotation.

As will be appreciated in view of the disclosure herein, a number of components of the sheave assembly 6005 may thus be collectively moving in one or more directions. For example, in one embodiment, virtually all components on shaft 6001 may collectively rotate with shaft 6001. In some embodiments, however, actuators 6047 may be connected to shaft 6047 using a bearing surface, such that actuators 6047 need not rotate as shaft 6001 rotates. Further, cross-over shaft 6032 may also be on a bearing surface (e.g., with the housing of the transmission), such that cross-over shaft 6032 and gears 6030 do not rotate around shaft 6001. Other components, however, such as sheaves, worm gears, turbine disks, and the like, may co-rotate with shaft 6001.

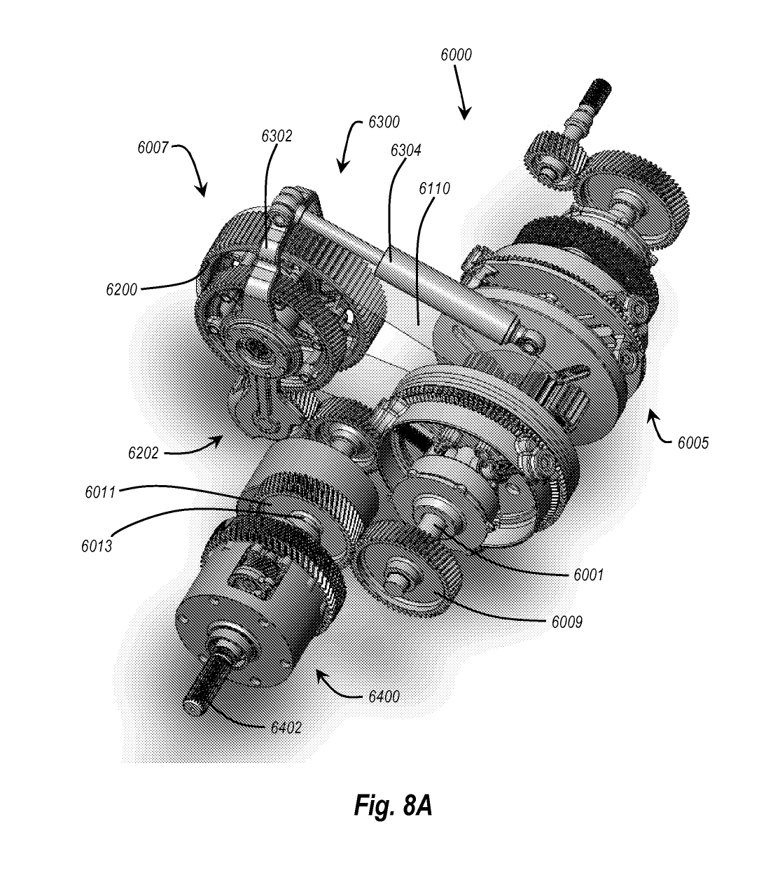

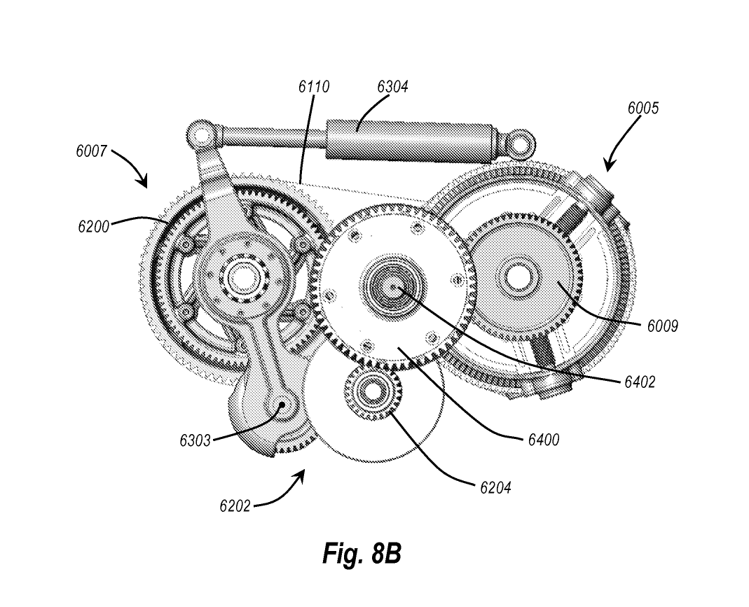

Turning now to FIGS. 8A and 8B, another exemplary aspect of a transmission 6000 is described in additional detail. Transmission 6000 may include various aspects as described above. Accordingly, the following discussion related to FIGS. 8A and 8B is intended to provide additional detail with respect to various components, assemblies, and features, but is not intended as a complete discussion of transmission 6000. Accordingly, other aspects of exemplary transmissions as described herein are also incorporated into, and usable in connection with, transmission 6000 of FIGS. 8A and 8B.

As reflected in FIGS. 8A and 8B, transmission 6000 may include variety of different components and assemblies. In one exemplary embodiment, transmission 6000 includes a sheave assembly 6005 and an output assembly 6007. Output assembly 6007 is optionally connected to sheave assembly 6005 by using a wrapping member 6110 that wraps at least partially around sheave assembly 6005 and output assembly 6007. Wrapping member 6110 may include a chain or belt, although in other embodiments, other components such as gears, may connect output assembly 6007 to sheave assembly 6005. In the illustrated embodiment, wrapping member 6110 is schematically illustrated to represent that multiple types of components may be used to connect sheave assembly 6005 and output assembly 6007.

While output assembly 6007 is illustrated without sheaves, it will also be appreciated in view of the disclosure herein that output assembly 6007 may also have sheaves or be otherwise configured. In still other embodiments, sheave assembly 6005 may have a driven gear and lack sheaves. Accordingly, while the illustrated embodiment shows that wrapping member 6110 may engage a driven chain gear 6200 of output assembly 6007, with driven chain gear 6200 acting as a sprocket. Notably, this embodiment is exemplary only. In other embodiments, wrapping member 6110 may engage a set of sheaves, a sheave cluster, internal moon gears, and/or other types of output gears or members.

In this embodiment, output assembly 6007 is connected to a tensioning assembly 6300. As discussed herein, sheave assembly 6005 may be configured such that it can move wrapping member 6110 radially relative to the axis of sheave assembly 6005. As wrapping member 6110 moves, tension or slack may occur within wrapping member 6110. In some embodiments, tensioning assembly 6300 may be used to adjust the tension in wrapping member 6110 so as to increase or decrease the slack therein. For instance, when wrapping member 6110 moves on sheave assembly 6005 to increase the tension, tensioning assembly 6300 may be used to relieve some of the tension. Alternatively, when wrapping member 6110 moves on sheave assembly 6005 and slackens, tensioning assembly 6300 may be used to increase the tension. Accordingly, although not necessary, tensioning assembly 6300 can be used to dynamically adjust the tension in wrapping member 6110. In some embodiments, tensioning assembly 6300 may be used to maintain wrapping member 6110 at a generally constant tension despite changes in gear ratios and/or positioning of wrapping member 6110.

To facilitate increasing or decreasing the tension in wrapping member 6110, tensioning assembly 6300 may be configured in any suitable manner. According to one embodiment, such as that illustrated in FIGS. 8A and 8B, tensioning assembly 6300 may include a tensioner arm 6302 and a tensioner 6304. In the illustrated example, tensioner arm 6302 is arranged such that it engages with, and optionally holds thereon, driven chain gear 6200. As a result, by moving tensioner arm 6302, the position of driven chain gear 6200 may be altered, thereby changing the path of wrapping member 6110 and affecting the tension in wrapping member 6110. More particularly, the illustrated embodiment of tensioner arm 6302 is configured to be fixed at a pivot 6303, and connected to tensioner 6304 at a location displaced from pivot 6303. Thus, as tensioner 6304 applies a force to tensioner arm 6302, the direction of the force can cause tensioner arm 6302 to rotate around pivot 6303 in either of two directions.

Tensioner arm 6302 may further be connected to tensioner 6304. In some embodiments, tensioner 6304 may act as an actuator, or be connected to an actuator. Thus, upon determining that a change in the tension of wrapping member 6110 is desired, tensioner 6304 can be actuated to move tensioner arm 6302. As shown in FIGS. 8A and 8B, tensioner 6304 may have a piston/cylinder arrangement to facilitate movement of tensioner arm 6302. Such an arrangement may be actuated in any suitable way, including mechanically, electrically, pneumatically, or hydraulically. In the illustrated embodiment, one end of tensioner 6304 is illustrated as being free. Such a free end may be connected to a transmission housing (not shown) to ground against such housing in providing the actuating force to move tensioner arm 6302. While a piston/cylinder actuator is illustrated, still other types of actuators may be used. Indeed, any suitable actuator that may be used to adjust the position of sheave assembly 6005, output assembly 6007, and/or wrapping member 6110 may be used to tension wrapping member 6110.

In view of the disclosure herein, it will thus be appreciated that some example embodiments may operate in a manner that does not require sheaves to act in opposing directions. More specifically, a conventional CVT may operate with a belt disposed between two sets of sheaves. To effect gear ratio changes, the sheaves may move inward or outward, thereby changing the positioning of the belt. To maintain tension in the belt, the sheaves act in opposite directions. In the illustrated embodiment, however, the use of a chain and single sheave allows a sheave to optionally move in one direction, with a rotating arm and actuator used to maintain the tension in the wrapping member, but without a sheave moving opposite a first sheave. In still other embodiments, the tension in a chain or other wrapping member may be adjusted by a tensioner that operates on one or both of an input assembly, as well as on a pair of sheave clusters. Accordingly, the tensioner may operate on a sheave, on a sheave cluster, on multiple sheave clusters, on a sprocket, or in any other suitable manner.

With continued reference to FIGS. 8A and 8B, another optional aspect of transmission 6000 is described in additional detail. More particularly, transmission 6000 may include a reverse differential 6400. In some embodiments, reverse differential 6400 may have two inputs that are combined to produce a single output. For instance, in the illustrated embodiment, reverse differential 6400 may have a first reverse differential input provided by a reverse differential input shaft 6013, as well as a second reverse differential input provided by a carrier driver 6204. Within reverse differential 6400, these two inputs may be combined in a manner that produces a single output, such as may be received at output shaft 6402.

To provide the two described, exemplary inputs to reverse differential 6400, a pass-through shaft 6001 may be positioned within at least a portion of sheave assembly 6005. In one embodiment, pass-through shaft 6001 may pass through all, or substantially all, of sheave assembly 6005. In such an embodiment, the rotational speed of pass-through shaft 6001 may be directly related to the input to transmission 6001, or may otherwise be related to a partial gear-ratio that may not be influenced by, for example, output assembly 6007. Pass-through shaft 6001 may, in this example, also be connected to a first input transfer gear 6009. A second input transfer gear 6011 that is optionally aligned with reverse differential input shaft 6013 may engage first input transfer gear 6009. In such a manner, the rotational speed of pass-through shaft 6001 may be passed to reverse differential input shaft 6013, although one or more transfer or other gears may effect a gear ratio between the rotational speed of pass-through shaft 6001 and the rotational speed of reverse differential input shaft 6011.

In this exemplary embodiment, the second input to reverse differential 6400 is optionally received from an output of output assembly 6007. More particularly, output assembly 6007 includes a driven chain gear 6200 that is driven by wrapping member 6110. Driven chain gear 6200 may be connected to, engage, or otherwise be related to one or more other gears of a drive output gear chain 6202. Drive output gear chain 6202 may be configured to receive a rotational or other input from driven chain gear 6200 and translate the input to a carrier driver 6204. Carrier driver 6204 is, in this embodiment, a gear configured to mate with an external gear profile on a housing of reverse differential 6400. By virtue of such relationship, the output of driven chain gear 6200 may be transmitted to carrier driver 6204, which in turn may cause the housing of reverse differential 6400 to rotate. Internal components of reverse differential 6400 may be fixed to the housing, such that the internal components may thus also receive a rotation causing them to orbit around a rotational axis of reverse differential 6400.

### F. ALTERNATIVE CORRECTION AND BRAKING MECHANISMS

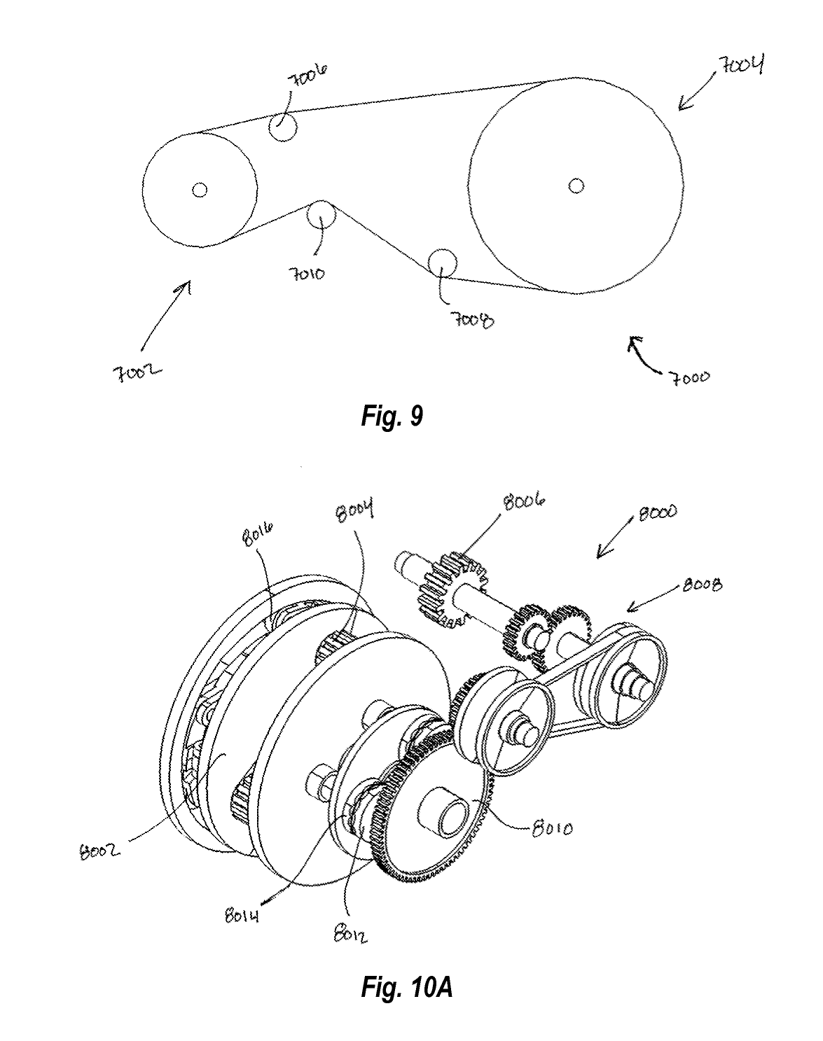

FIG. 9 schematically illustrates an example of a transmission system 7000 that includes a drive system 7002 and a driven system 7004. The drive system 7002 can include, for example, a sheave and one or more sprockets. Exemplary embodiments of such a drive system include those described herein. The driven system 7004 can also include a sheave and one or more sprockets, and may be consistent with embodiments described herein. In some embodiments, only the drive system 7002 or the driven system 7004 includes a sheave, while the other of the drive and driven systems 7002, 7004 includes a gear of a fixed size.

In FIG. 9, a set of additional gears or other components may also engage a chain belt, or other wrapping member that extends between the drive and driven systems 7002, 7004. For instance, in this embodiment, three components 7006, 7008, 7010 may be used. According to one embodiment, two of the components (e.g., component 7006, 7008) have a fixed position. A third component (e.g., 7010) may be moveable. In such an embodiment, the third component 7010 may act in some embodiments as a tensioner that can be used to adjust the tension in the wrapping member. For instance, the tension may be adjusted to remain constant while changes in gear ratios occur, or the tension may vary as desired.

The other two components 7006, 7008 may also be used in any suitable manner. According to one embodiment one or both of the components 7006, 7008 act as reference components. For instance, as discussed herein, one aspect of an infinitely variable transmission is that such a transmission may operate at non-integer ratios. At such ratios, the size of the sheave may not correspond to an integer number of gear teeth (e.g., gear teeth, chain pitch, etc. may not be wholly divisible into the circumference of the chain around a reference circle). As a result, some correction in gear teeth may be performed. As discussed, such correction may be performed by, for instance, using a sensor or encoder that determines a position of the sheave, chain, sprocket, and/or other components, and adjusts the position of a sprocket to correspond to a proper pocket location in a chain.

According to another embodiment, a mechanical, electrical, or other system, may monitor the follower. In particular, once the chain size is known, the components 7006, 7008 can have fixed locations. By monitoring or otherwise knowing the position of such a fixed component, the location of the chain can be determined, as well as the required position of the teeth of a sprocket.

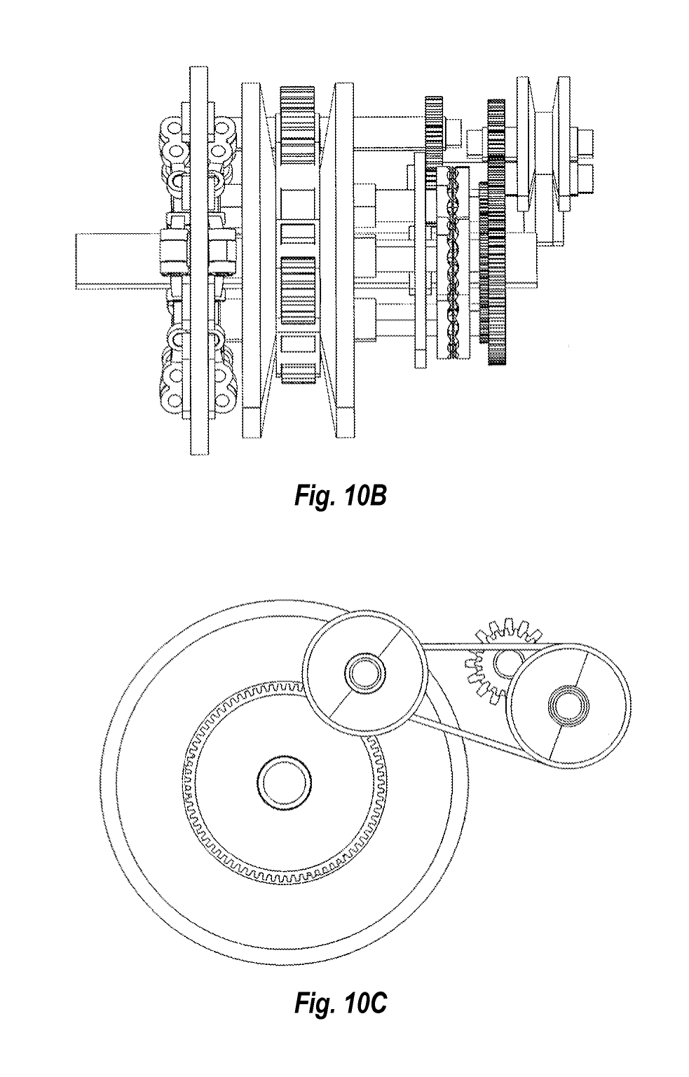

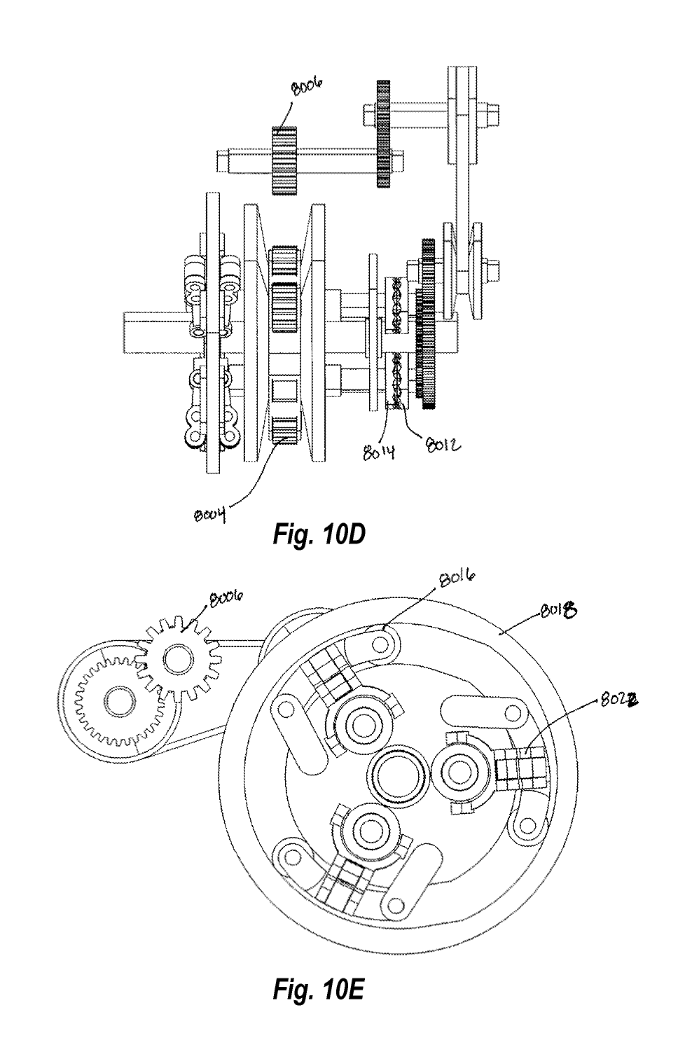

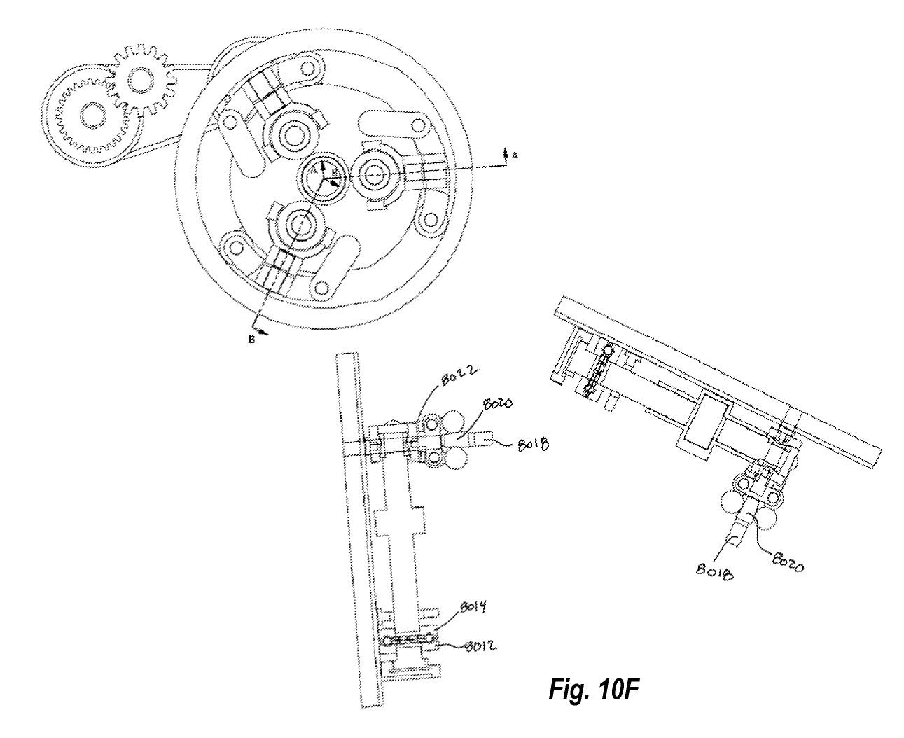

FIGS. 10A-10F illustrate aspects of an exemplary system generally corresponding to the schematically illustrated transmission system 8000 of FIG. 9. In the transmission system 8000 of FIGS. 10A-10F, a single side of a transmission is illustrated (e.g., an input system), although it will be appreciated that other exemplary embodiments may include the illustrated system as a driven system, or in both drive and driven systems.

According to the embodiment in FIGS. 10A-10F, a sheave 8002 includes one or more sprockets 8004 therein. The sprockets 8004 and sheave 8002 may be configured to receive a chain or other wrapping member. A follower gear 8006 may also be included. The follower gear 8006 may correspond, for example, to a static component illustrated in FIG. 9. For instance, in this embodiment, a gear train 8008 is coupled to the follower gear 8006. The gear train 8008 couples to a drive ring 8010. The drive ring 8010 can, in turn, be coupled to a shaft on which the sprockets 8004 rotate. Thus, rotation of the follower gear 8006 can be directly tied to the rotation of the sprockets 8004.

In some embodiments, the sprockets 8004 are corrected by the illustrated system so as to maintain proper tooth position for tooth engagement with a chain. In one embodiment, a correction mechanism includes a set of pocketed rings 8012, 8014. Inside the rings 8012, 8014 are a set of balls. The balls ride in the pockets of the rings. The size of the pockets may correspond, for instance, to the pitch of the teeth on the sprockets and/or the pitch of the chain.

In some cases, the pocket rings are spring loaded. For instance, as the follower gear 8006 indicates some correction is needed, the pocket ring 8012 most near the drive ring 8010 may rotate. Such pocket ring 8012 may be spring loaded. As the rotation corresponds to a full pitch, the spring may snap back in place, thereby releasing the biasing force. The balls between the pocket rings 8012, 8014 may cause the second pocket ring 8014 to attempt to align with the first pocket ring 8012. The amount of movement required for alignment may correspond to an amount of adjustment needed to correct a tooth of the sprockets 8004 to be in a proper position for chain alignment.

A braking mechanism is also illustrated, particularly with respect to FIGS. 10E and 10F. In this embodiment, a braking mechanism is coupled to the shafts on which the sprockets 8004 rotate. Attached to such shafts are cam followers 8016 which follow a ring 8018 that has a cam profile. In FIG. 10E, it can be seen that the illustrated cam profile has a constant arc over approximately two hundred forty degrees, and a second profile over one hundred twenty degrees. Over the one hundred twenty degrees, the cam profile may cause the cam to lock down on the shaft of the sprockets to cause them to lock and be at a fixed position, thereby avoiding rotation that may cause slippage between the chain and sheave.

In practice, the cam roller may attach to a wedge 8020 and a yoke 8022 riding on the wedge 8020. As the cam profile changes, the wedge 8020 can be moved, and can cause the yoke 8020. The yoke 8020 may then engage the sprocket shaft at the locked position (e.g., using an angle, plate, or other clutching mechanism). Such movement may lock the shaft in place to prevent or limit rotation.

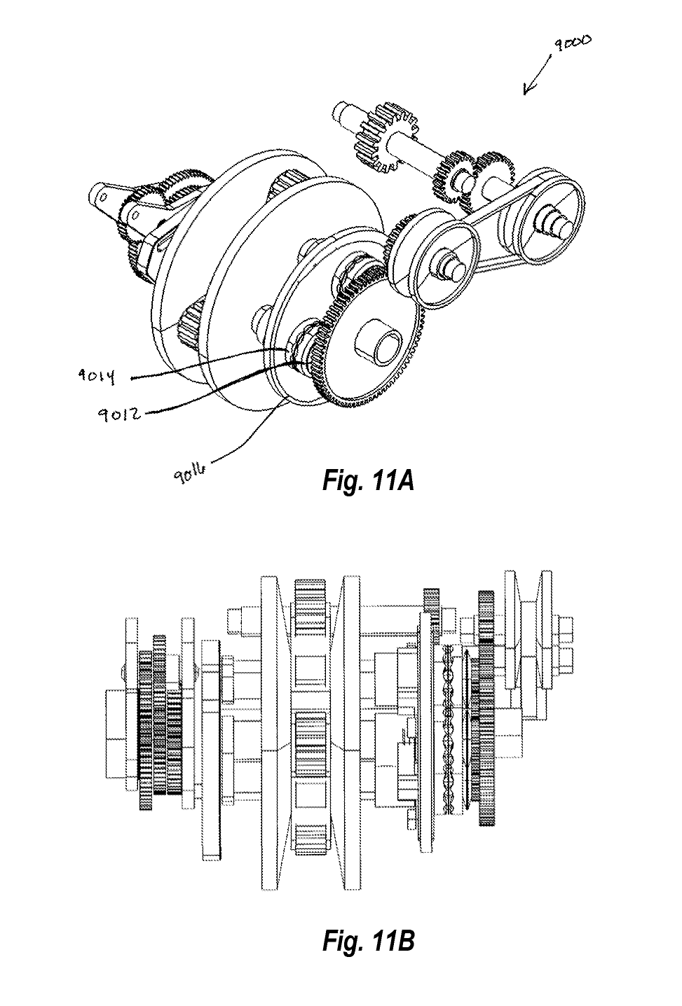

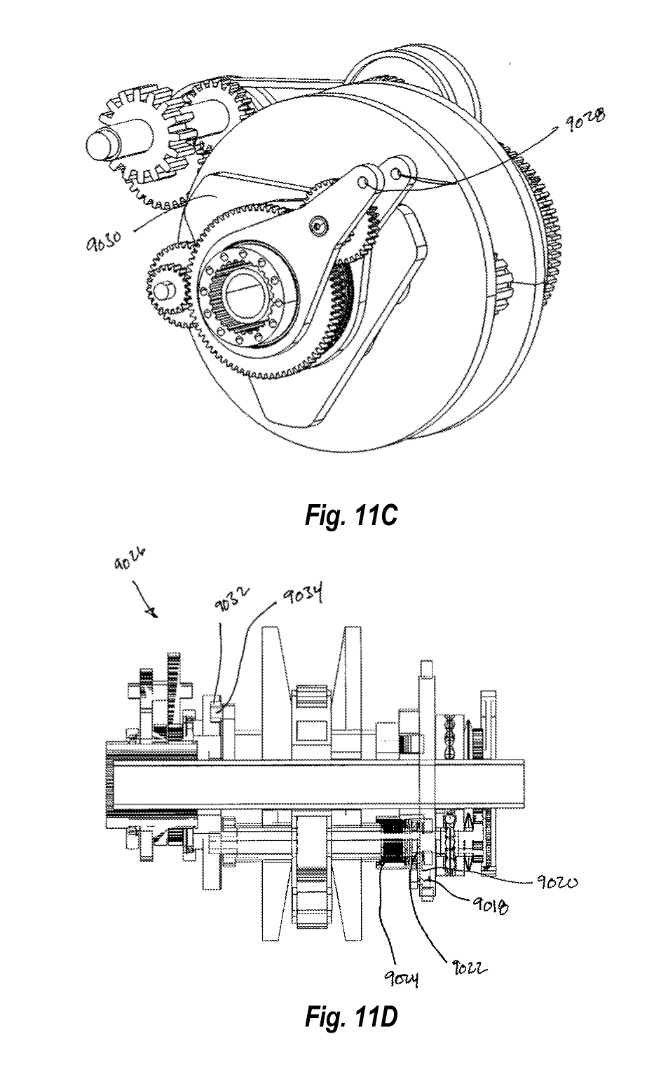

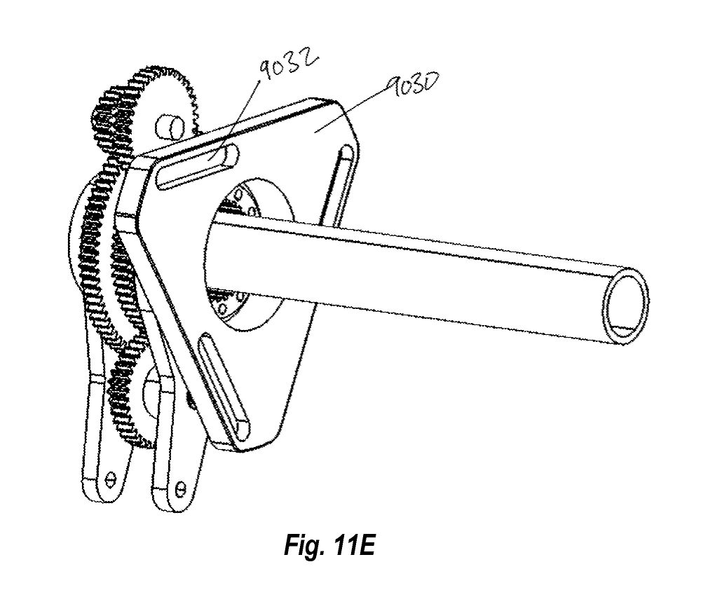

FIGS. 11A-11E illustrate still another example embodiment of an exemplary correction system and braking mechanism. In FIGS. 11A-11D, the correction system and braking mechanism are on a same side of a sheave. For instance, the system 9000 includes a set of pocket rings 9012, 9014 that may operate in a manner similar to that described above with respect to FIGS. 10A-10F. In this embodiment, a cam ring 9016 has a profile that can cause a brake to selectively lock sprocket axles in place. For instance, as best shown in FIGS. 11D and 11E, a cam follower 9018 may be attached to an action arm 9020. When the cam profile causes the action arm 9020 to move, the action arm 9020 can compress a spring 9022 (e.g., a Bellville spring), as well as a set of clutch plates 9024. In such an engagement, the sprocket axle may be locked, although in other embodiments compressing the clutch plates may allow the axle to rotate freely.

In another aspect, the transmission system 9000 includes an alternative exemplary sprocket adjustment system 9026. The illustrated system may be used to, for instance, cause sprockets to move radially with respect to a sheave. In this embodiment, for instance, the sprocket adjustment system 9026 may be rotatable independent of the sheaves. For instance, in an embodiment discussed herein, one or more servo or stepper motors, or other actuators, may connect to the sheave and rotate with the sheaves. The sprocket adjustment system 9026 may, however, rotate independent of the sheaves. For instance, two actuator arms 9028 may be connected to a separate actuator. As the actuator arms 9028 are rotated, a set of gears may link to a traction ring 9030. In one embodiment, the traction ring 9030 includes a cam track 9032. As the actuator arms 9028 are moved relative to the sheave assembly, a follower 9034 within the track may move. Movement within the track can cause an arm coupled to the follower 9034 to move, and the arm can also be coupled to the sprockets to cause the sprockets to move between extended and retracted positions.

### G. LOCKING CONTINUOUSLY VARIABLE TRANSMISSION (CVT)

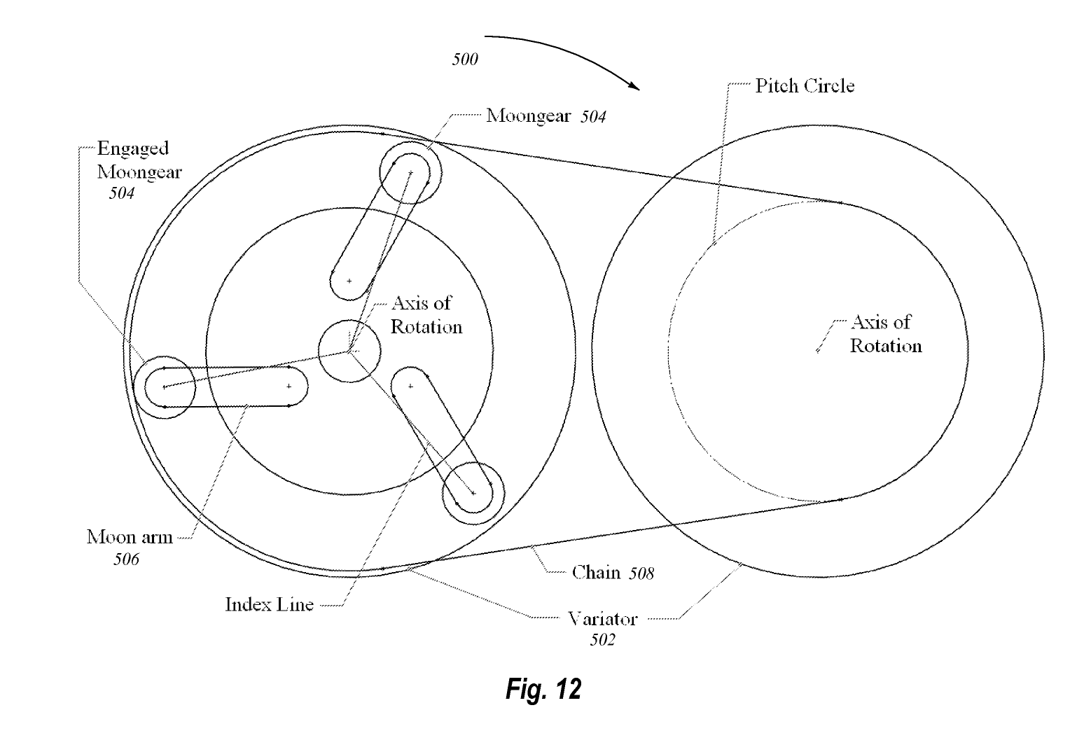

As will be evident from the disclosure herein, and with reference now to FIGS. 12-14, example embodiments of the disclosed transmission and related systems can operate at a wide variety of different drive ratios in a particular range of drive ratios. The set of drive ratios in the range over which such a transmission, such as transmission 500 for example, may operate can include integer ratios, non-integer ratios, or combinations of the two. In general, the number of integer ratios in a range of drive ratios is a function of the physical characteristics of the transmission system and its components. Such physical characteristics may include, among others, aspects of the variator 502 geometry such as the maximum and minimum operating diameters of the variator where the variator is implemented as a sheave, the size and number of drive members, such as moon gears 504 for example, and the length of the driven member, such as a chain 508 for example, and the number of links in the chain, if a chain 508 is employed.

It should be understood that while reference is made herein to a CVT that includes moon gears 504, each of which may or may not be connected to a corresponding moon arm 506, configured to engage a chain 508, the moon gear 504 and chain 508 configuration is presented solely by way of example, and the scope of the invention is not limited to such examples. More generally, and as should be apparent from the disclosure, the invention embraces, among other things, driving members, of which moon gears 504 are but one example, and driven members, of which a chain 508 is but one example.

Moreover, members such as the moon gears 504 and chain 508 are not limited to the example functionalities noted above. By way of illustration, chain 508 may serve as a drive member and/or driven member, and the moon gears 504 may act as driven members and/drive members.

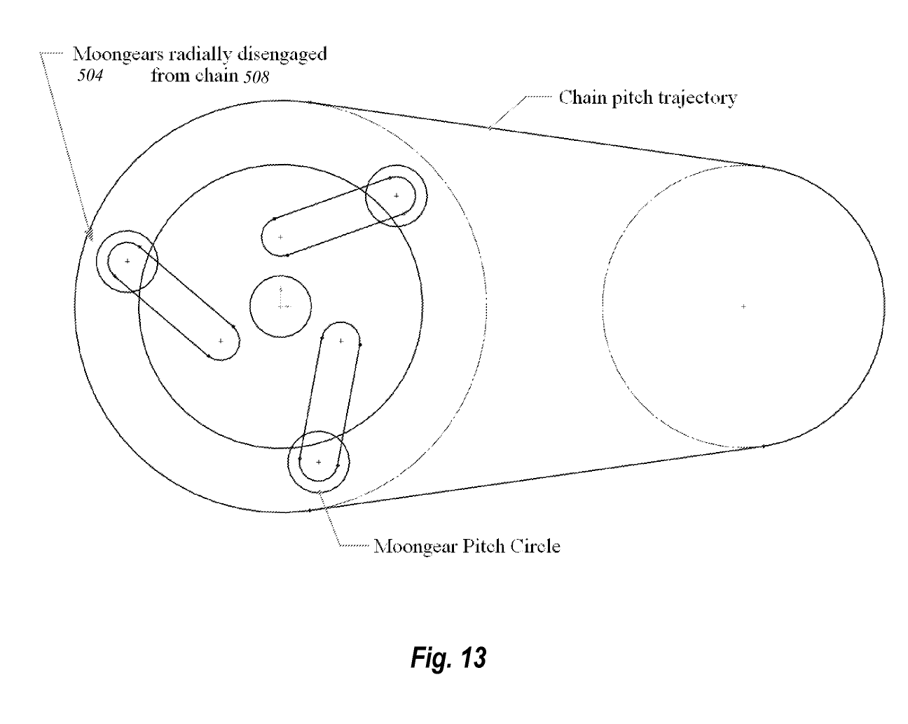

As the foregoing makes clear then, one advantage of at least some embodiments of the transmission system 500 is that they are able to operate at a relatively large number of drive ratios in a given range of drive ratios. Such functionality can provide great flexibility in terms of the various operating points of the transmission. A mode of operation where the transmission system can operate at a relatively large number of drive ratios, that include both integer and non-integer drive ratios, is referred to herein as an infinite mode of operation because while any physical system may define only a certain number of integer drive ratios, that same system can also operate at a substantially larger number of non-integer ratios. This is because, as explained further below and disclosed in FIGS. 12 and 13, the moon gears 504 can be indexed to virtually any desired angle necessary to engage the chain 508, and are not limited to operating only at angles that correspond to integer ratios. As well, at least where the variator 502 takes the form of a sheave 510 of variable diameter, a large number of sheave 510 diameters can be defined and employed.

Thus, the infinite mode nomenclature reflects the fact that a relatively large number of index variations, each corresponding to a respective non-integer drive ratio, can be made to each of the moon gears 504, and further reflects that fact that variations can be made as well to the sheave 510 diameter. With regard to adjustment, also sometimes referred to as indexing, of the moon gears 504, it should be noted that examples of components and devices for adjusting moon gear 504 positions, which may sometimes be referred to as correction mechanisms, are disclosed and discussed elsewhere herein.

While operation in the infinite mode provides a great degree of flexibility and is thus desirable in some applications, a lesser degree of flexibility may be adequate, and even desirable, in other applications. That is, certain applications may only need to operate at a relatively small number of gear ratios. Thus, in some applications, only the relatively smaller set of integer drive ratios, i.e., smaller relative to the set of non-integer drive ratios, defined by the transmission system are employed in the operation of the transmission system. It should be noted that while, for a given transmission, the set of integer drive ratios may be relatively smaller than the set of non-integer drive ratios for that transmission, the set of integer drive ratios may nonetheless be significantly larger than the set of drive ratios employed in a conventional transmission.

The operational mode where only integer drive ratios are employed may be referred to as the integer mode. This can be thought of as the relatively more general case in which the drive ratio may be any integer. A more specific case of the integer mode is the I_{N} mode where the moon gears 504 engage the chain 508 in the particular I_{N} relationship disclosed elsewhere herein, although other specific relationships may also be defined and employed. Other differences between the integer mode and the I_{N} mode are noted below.

In the integer and I_{N} modes, the moon gears 504 may be maintained at index positions that correspond with the drive ratio desired to be employed and, accordingly, no indexing of the moon gears 504 is required until such time as it is desired to change the drive ratio. In this sense, the transmission system 500 is ‘locked’ or ‘lockable,’ and a transmission that can and/or does operate in this way may be referred to as a locking CVT. Correspondingly, the drive ratios employed in the integer and I_{N} modes may be referred to as locking ratios. By way of comparison, when the transmission system 500 operates in the infinite mode, the index position of a given moon gear 504 may need to be adjusted more frequently, as often as after every disengagement of that moon gear 504 from the chain 508, in order to attain the desired position of the moon gear 504 relative to the chain 508. As should be apparent, a locking CVT may be advantageous in some circumstances inasmuch as little or no slippage between the variator 502 and belt/chain 508, for example, occurs when the moon gears 504 are locked into index positions that correspond with an integer drive ratio.

In view of the fact that the number and value of integer drive ratios are a function of the physical configuration of the transmission system 500 and its components, it should be apparent that specific desired integer drive ratios for a given transmission can be implemented by appropriately designing the transmission and its components. For purposes of illustration only, a desired I_{N} drive ratio can be implemented by specifying a number of links engaged per revolution of the variator 502, and by specifying the size and number of moon gears 504 to be used. Additional, or alternative, physical aspects of the transmission may be designed and implemented so as to achieve a desired set of integer drive ratios.

Finally, it should be understood that a locking CVT as disclosed herein is one example of a structural implementation of a means for transmitting power, where the power may be transmitted by the means at integer and/or non-integer drive ratios. Any other structures, systems and/or devices of comparable functionality to the locking CVT may alternatively be employed.

### H. EXAMPLE MODES OF OPERATION

A CVT of having one or more variators of adjustable width sheave type, or other device(s) of comparable functionality, and lockable drive members, such as moon gears for example, may be operable in one or more of the following modes.
1. Traction mode: Only friction transmits power from the sheave to the chain.
2. Integer mode: The drive ratio is any integer and the chain transmits power primarily by engaging the moon gears. The moon gears may, and in at least some instances may be required to, initially index independent of one another to the appropriate angle with respect to the index line and, at any given time, one or more moon gears may be engaged with the chain while, at the same time, one or more other moon gears are disengaged from the chain (see FIG. 12).
3. I_{N} mode: The chain transmits power primarily by engaging the moon gears in an I_{N} relationship. The moon gears do not index independently of one another.
4. Infinite mode: The moon gears index to whatever angle is necessary to engage the chain during the period between disengagement and reengagement of the moon gears with the chain. The moon gears necessarily lock, unlock, and move as appropriate during operation to deliver power and account for the rake of the chain with respect to the drive ratio.

### I. EXAMPLE SHIFT SEQUENCES

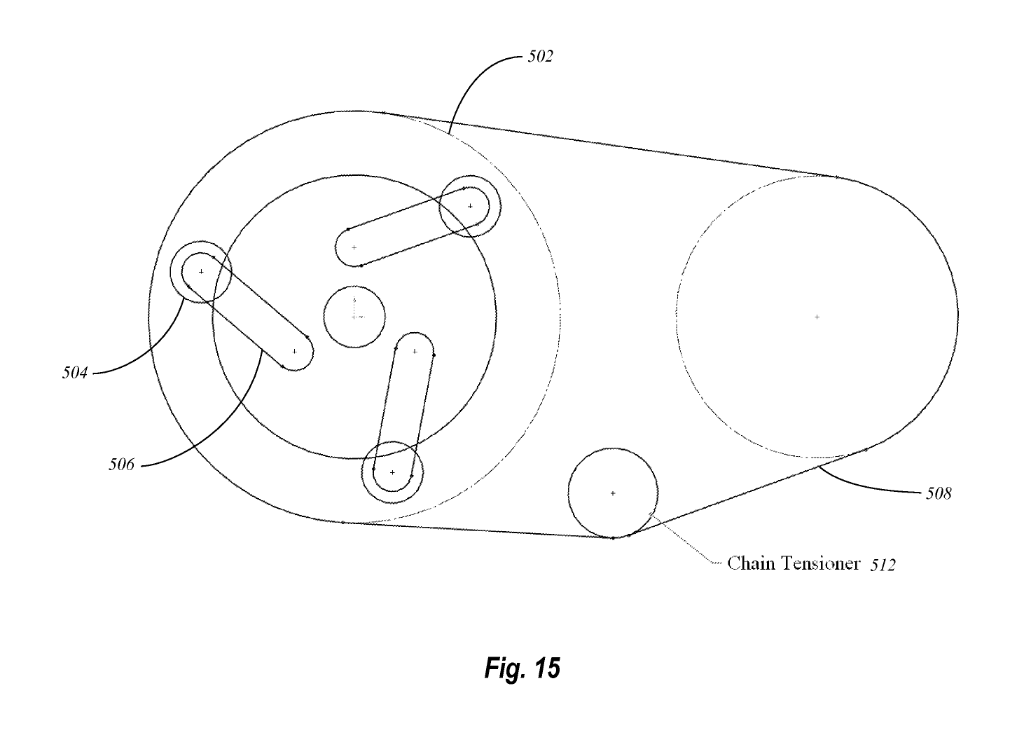

It should be noted with regard to the example shift sequences disclosed herein that the slack side tension in any of the sequences may be substantially constant during the shift sequence, or may vary, i.e., can be dynamically adjusted during the shift sequence. In determining whether, and how much, fixed or variable slack side tension will be employed in a shift sequence, consideration may be given to the amount of component wear that attends particular tension levels, and consideration may also be given to changes in performance that attend different tension levels. In some instances, and as suggested in FIG. 15 for example, a tensioner, which may take the form of a chain tensioner 512, may be employed to aid in the achievement and/or maintenance of a desired tension level in the chain. Tensioners may be employed on the slack side and/or tension side of the driven member.

### Example Traction Shift Sequence:

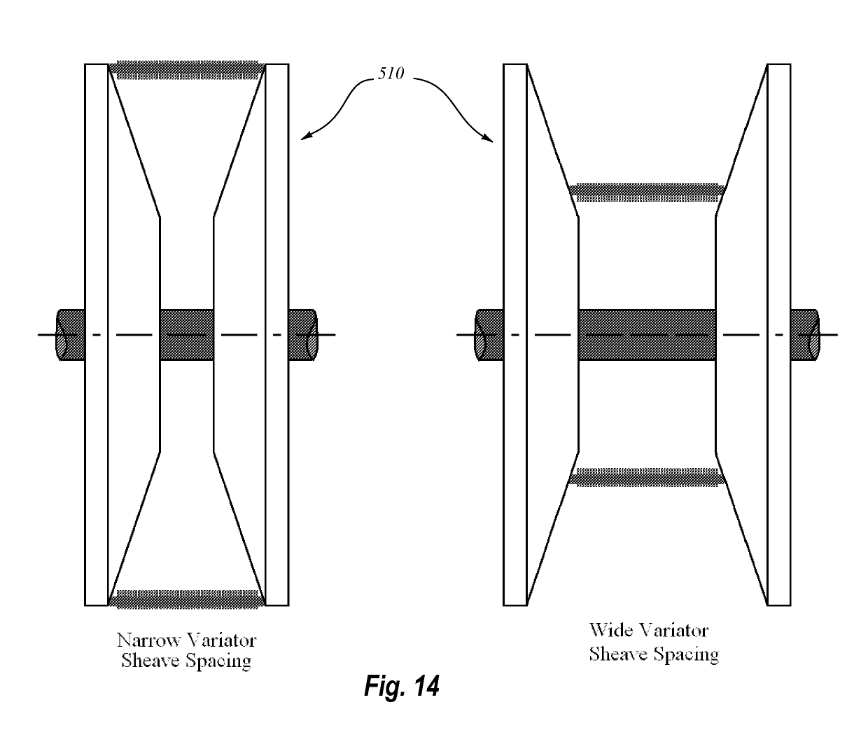

1. The controller initiates a shift cycle, either automatically or in response to a user input, to change the drive ratio of the transmission.
2. The variator adjusts its sheave spacing to correspond to the desired drive ratio (FIG. 14).
3. The chain tensioner adjusts during variator sheave spacing changes so as to maintain the desired chain slip rate (FIG. 15).

### Example Integer Operation Shift Sequence:

1. The controller initiates a shift cycle, either automatically or in response to a user input, to change the drive ratio of the transmission.
2. The drive members move radially inward out of engagement with the chain (FIG. 13)
3. The variator adjusts its sheave spacing so that the desired drive ratio is obtained (FIG. 14).
4. The controller adjusts the index position of the drive members so that they engage the chain properly, and this index position is maintained until the next shift sequence.
5. The drive members move radially outward to engage the chain (FIG. 12).
6. The chain tensioner maintains substantially constant slack side chain tension appropriate to the transmitted power of the system (FIG. 15).

### Example I_{N} Operation Shift Sequence:

1. The controller initiates a shift cycle, either automatically or in response to a user input, to change the drive ratio of the transmission.
2. The drive members move radially inward out of engagement with the chain (FIG. 13).
3. The variator adjusts its sheave spacing so that the desired drive ratio is obtained (FIG. 14).
4. The controller adjusts the engine output power and chain tension to control the relative position of the chain with respect to the index line of the drive members.
5. The drive members move radially outward into engagement with the chain (FIG. 12), and the index position of each drive member is maintained until the next shift sequence.
6. The chain tensioner maintains substantially constant slack side chain tension appropriate to the transmitted power of the system (FIG. 15).

### Example Infinite Operation Shift Sequence:

1. The controller initiates a shift cycle.
2. The variator adjusts its sheave spacing so that the desired drive ratio is obtained (FIG. 14).
3. While the variator adjusts, the drive members move radially to maintain proper engagement with the chain.
4. While the variator adjusts, the controller adjusts the index position of the drive members so that they engage the chain properly.
5. While operating in non-integer drive ratios, the controller adjusts the index position of the drive members during the period that they are disengaged from the chain.
6. The chain tensioner maintains substantially constant slack side chain tension appropriate to the transmitted power of the system (FIG. 15).

### J. CONTROL SYSTEMS AND DEVICES

It will be appreciated that one or more of the modes of operation and one or more of the shift sequences, including adjustments to slack side tension, can be performed and controlled with a variety of systems and devices, such as a controller for example. Such systems and devices may be, for example, manual, automatic, electrical, electronic, mechanical, or any combination of the foregoing. In at least some instances, software may be employed in the operation and control of such systems and devices.

What is claimed is:

1. A transmission, comprising:
a sheave of selectively variable configuration, the sheave defining a first axis of rotation;
a driven member configured to engage the sheave; and
a plurality of drive members configured to selectively engage the driven member, each of the drive members configured to rotate about a common second axis of rotation that is spaced apart from the first axis of rotation, the drive members being configured for radial movement relative to the second axis of rotation, wherein indexing of the drive members is implemented only in response to initiation of a change to a drive ratio of the transmission.

2. The transmission of claim 1, wherein the transmission is operable in one or more of the following modes: traction mode, integer mode, I_{N} mode, and infinite mode.

3. The transmission of claim 1, wherein each drive member is further configured to rotate about its own respective axis of rotation.

4. The transmission of claim 1, wherein one of the drive members is a sector gear.

5. The transmission of claim 4, wherein the sector gear is configured to translate radially relative to the second axis of rotation.

6. The transmission of claim 1, wherein one of the drive members is a moon gear that is connected to a moon arm, and the moon arm is configured to rotate about a third axis of rotation so as to change a radial position of the moon gear relative to the second axis of rotation.

7. The transmission of claim 1, wherein the driven member is one of a chain, and a belt.

8. The transmission of claim 1, wherein the drive members collectively define a virtual drive member having a diameter of variable size.

9. A vehicle including the transmission of claim 1, and further comprising:
a prime mover coupled at least indirectly to the transmission; and
a drive train coupled at least indirectly to the transmission.

10. A transmission, comprising:
a sheave of selectively variable configuration, the sheave defining a first axis of rotation;
a chain configured to engage the sheave; and
a plurality of sector gears configured to selectively engage the chain, each of the sector gears configured to rotate about a common second axis of rotation that is spaced apart from the first axis of rotation, the sector gears being configured to translate radially relative to the second axis of rotation, wherein indexing of the sector gears is implemented only in response to initiation of a change to a drive ratio of the transmission.

11. The transmission as recited in claim 10, wherein each sector gear is configured to rotate about its own respective axis of rotation.

12. The transmission as recited in claim 10, wherein a diameter of the sheave is selectively variable.

13. The transmission as recited in claim 10, wherein the plurality of sector gears comprises three sector gears.

14. The transmission as recited in claim 10, further comprising a chain tensioner configured to engage the chain.

15. The transmission as recited in claim 14, wherein the chain tensioner is positioned on a slack side of the chain.

16. The transmission as recited in claim 14, wherein the chain tensioner is positioned on a tension side of the chain.

17. The transmission as recited in claim 10, further comprising:
a first chain tensioner configured to engage the chain and positioned on a slack side of the chain; and
a second chain tensioner configured to engage the chain and positioned on a tension side of the chain.

18. A transmission system, comprising:
a transmission comprising:
a sheave of selectively variable configuration, the sheave defining a first axis of rotation;
a chain configured to engage the sheave;
a plurality of sector gears configured to selectively engage the chain, each of the sector gears configured to rotate about a common second axis of rotation that is spaced apart from the first axis of rotation, the sector gears being configured to translate radially relative to the second axis of rotation, wherein indexing of the sector gears is implemented only in response to initiation of a change to a drive ratio of the transmission; and
a controller operable to initiate a shift cycle of the transmission.

19. The transmission system of claim 18, wherein the controller is operable to cause an adjustment to an index position of each of the sector gears.

20. The transmission system of claim 18, wherein the transmission is operable in one or more of the following modes: traction mode, integer mode, I_{N} mode, and infinite mode.
